(19) United States
(12) Patent Application Publication
(10) Pub. No.: US 2013/0117576 A1
(43) Pub. Date: May 9, 2013

(54) CONVERTING APPARATUS, CONVERTING METHOD, AND RECORDING MEDIUM OF CONVERTING PROGRAM

(71) Applicant: FUJITSU LIMITED, Kawasaki-shi (JP)

(72) Inventors: Masahiro KATAOKA, Tama (JP); Susumu KOGA, Kawasaki (JP); Teruhiko ONISHI, Mishima (JP); Tetsuro HOSHI, Setagaya (JP)

(73) Assignee: FUJITSU LIMITED, Kawasaki-shi (JP)

(21) Appl. No.: 13/667,155

(22) Filed: Nov. 2, 2012

(30) Foreign Application Priority Data
Nov. 4, 2011 (JP) 2011-242830

(51) Int. Cl. G06F 17/30; G06F 12/14

(52) U.S. Cl. 713/189; 707/825; 707/E17.005

(57) ABSTRACT

A converting method includes storing correspondence of each of first-type coded information, included in a first-type coded information group, and one of second-type coded information, included in a second-type coded information group, based on input information, by a processor, and converting, when input data includes the first-type coded information, first-type coded information in the input data into second-type coded information, based on the correspondence.

### CROSS-REFERENCE TO RELATED APPLICATIONS

This application is based upon and claims the benefit of priority of the prior Japanese Patent Application No. 2011-242830, filed on Nov. 4, 2011, the entire contents of which are incorporated herein by reference.

### FIELD

The embodiments discussed herein are related to data transform.

### BACKGROUND

Heretofore, there have been apparatuses which compress digital content, encrypt the compressed digital content, and transmit the encrypted digital content. For example, a device heretofore has transmitted the compressed and encrypt digital content to a user terminal such as a PC (Personal Computer) or cellular phone. Note that examples of digital content may be a movie, music, a book or dictionary, for example. Also, the encrypted digital content is decrypted at the user terminal, and the decrypted digital content is decompressed. The decompressed digital content is then played on the user terminal.

Also, a device exists, wherein, in the case that a symbol included in the input data is registered in a dictionary, the compression encoding corresponding to the symbol is scrambled, and in the case that a symbol is not registered in a dictionary, the raw data is scrambled, and the scrambled symbol is output.

Also, a device exists wherein an adaptive template is used and predictive encoding is performed as to the data, and the data is compressed with a compression method that performs arithmetic encoding of the predictive encoding results. In such a device, image information is encrypted using position information of the pixels of a floating template applied with the adaptive template.

However, in the current technologies described above, encryption processing is performed in addition to compression processing having been performed, or decompressing processing is performed in addition to decryption processing having been performed, so the processing cost is increased according to the amount of data to be processed.

### SUMMARY

According to an aspect of the invention, a converting method includes storing correspondence of each of first-type coded information, included in a first-type coded information group, and one of second-type coded information, included in a second-type coded information group, based on input information, by a processor, and converting, when input data includes the first-type coded information, first-type coded information in the input data into second-type coded information, based on the correspondence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system configuration according to a first embodiment;

FIG. 2 illustrates an example of a content database;

FIG. 3 illustrates an example of a trie;

FIG. 4 illustrates an example of a case where the compression code of a first generation of a trie has been changed;

FIG. 5 illustrates an example of a case where leaves and nodes have been added in the second generation and thereafter of a trie;

FIG. 6 illustrates an example of processing of a modified portion;

FIG. 7 illustrates a sequence example of a system according to the first embodiment;

FIG. 8 illustrates procedures of compression processing according to the first embodiment;

FIG. 9 illustrates procedures of decompressing processing according to the first embodiment;

FIG. 10 illustrates an example of a system configuration according to a second embodiment;

FIG. 11 illustrates an example of processing to be executed by the system according to the second embodiment;

FIG. 12 illustrates an example of processing to be executed by the system according to the second embodiment;

FIG. 13A is a flowchart describing a procedure example of compression processing according to the second embodiment;

FIG. 13B is a flowchart describing a procedure example of compression processing according to the second embodiment;

FIG. 14A is a flowchart describing a procedure example of decompression processing according to the second embodiment;

FIG. 14B is a flowchart describing a procedure example of decompression processing according to the second embodiment;

FIG. 15 illustrates an example of a system configuration according to a third embodiment;

FIG. 16 illustrates an example of information stored in a storage unit;

FIG. 17 illustrates an example of modification to the compression encoding in the third embodiment;

FIG. 18 is a flowchart describing a procedure example of compression processing according to the third embodiment;

FIG. 19 is a flowchart describing a procedure example of decompression processing according to the third embodiment;

FIG. 20 illustrates an example of a system configuration according to a fourth embodiment;

FIG. 21 illustrates an example of processing to be executed by the system according to the fourth embodiment;

FIG. 22A is a flowchart describing a procedure example of compression processing according to the fourth embodiment;

FIG. 22B is a flowchart describing a procedure example of compression processing according to the fourth embodiment;

FIG. 23A is a flowchart describing a procedure example of decompression processing according to the fourth embodiment;

FIG. 23B is a flowchart describing a procedure example of decompression processing according to the fourth embodiment;

FIG. 24 illustrates an example of a system configuration according to a fifth embodiment;

FIG. 25 illustrates an example of a reserved word table;

FIG. 26A illustrates an example of a character string generated by a generating unit;

FIG. 26B illustrates an example of a character string generated by a generating unit;

FIG. 27 illustrates processing of the system according to the fifth embodiment;

FIG. 28 is a flowchart describing a procedure example of compression processing according to the fifth embodiment;

FIG. 29 is a flowchart describing a procedure example of decompression processing according to the fifth embodiment;

FIG. 30 illustrates an example of a system configuration according to a sixth embodiment;

FIG. 31A illustrates an example of a dictionary expressed by a Huffman tree;

FIG. 31B illustrates an example of a case wherein the dictionary indicated in the example in FIG. 31A has been modified;

FIG. 32 is a flowchart describing a procedure example of compression processing according to the sixth embodiment;

FIG. 33 is a flowchart describing a procedure example of decompression processing according to the sixth embodiment;

FIG. 34 illustrates a computer that executes a compression program; and

FIG. 35 illustrates a computer that executes a decompression program.

### DESCRIPTION OF EMBODIMENTS

Hereinafter, each embodiment of a decompression program, compression program, compression apparatus, decompression apparatus, compression method, and decompression method disclosed by the present application will be described in detail based on the appended diagrams. The embodiments do not limit the disclosed technology. Also, the embodiments can be combined as appropriate, within the scope of not contradicting the processing content. Note that the decompression program and the compression program are examples of a converting program. Also, the compression device and the decompression device are examples of a converting device. Also, the compression method and the decompression method are examples of a converting method.

First, a first embodiment will be described.

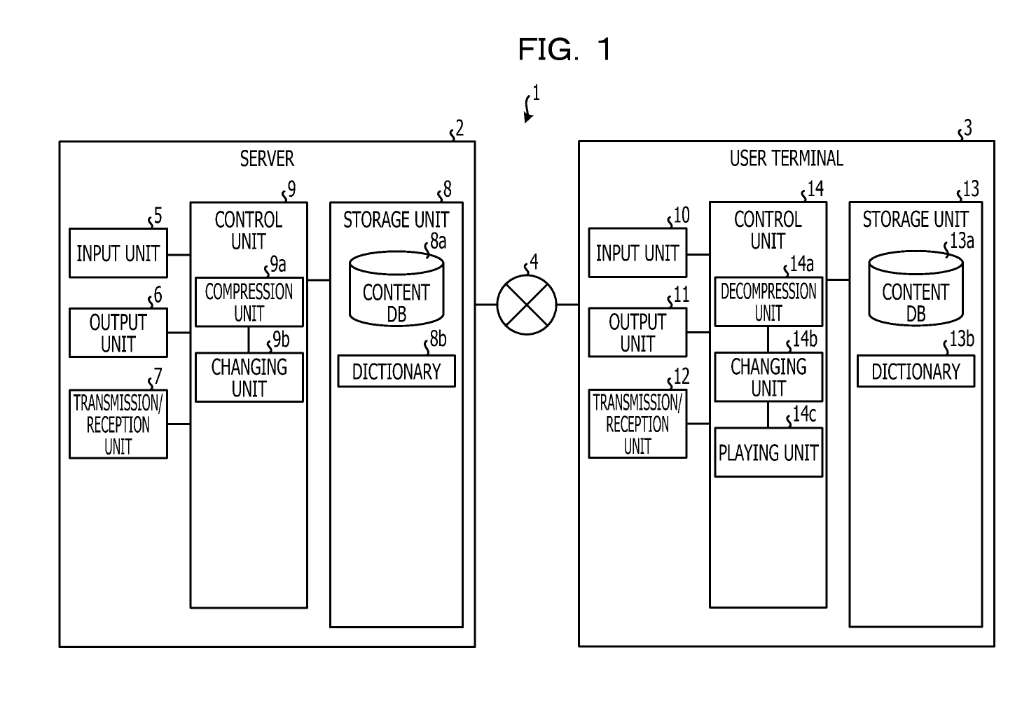

A system according to the first embodiment will be described. FIG. 1 is a diagram illustrating an example of a system configuration according to the first embodiment. A system 1 according to the present embodiment has a server 2 and a user terminal 3. The server 2 and user terminal 3 are connected so as to enable data transmission/reception. In the example in FIG. 1, the server 2 and user terminal 3 are connected via an Internet 4. Note that the server 2 and user terminal 3 may be connected wirelessly. The server 2 compresses file data of digital content such as a dictionary or electronic book. The server 2 transmits the compressed digital content file data to the user terminal 3 via the Internet 4. The user terminal 3 decompresses the received digital content file data. The user terminal 3 plays the decompressed digital content file.

The server 2 has an input unit 5, output unit 6, transmission/reception unit 7, storage unit 8, and control unit 9.

The input unit 5 inputs various types of information in the control unit 9. For example, the input unit 5 receives digital content from a user, and inputs the received digital content into the control unit 9. Also, the input unit 5 receives instructions to executed compression processing which is to be described later, and inputs the received instructions into the control unit 9. Also, the input unit 5 receives a password from the user and inputs the received password into the control unit 9. Examples of a password may be numbers or letters of the alphabet. For example, a password may be a four-digit number “3212”. Also, an example of a device of the input unit 5 may be an operation receiving device such as a mouse or keyboard.

The output unit 6 outputs various types of information. For example, the output unit 6 displays the operating state of the server 2. Examples of device of the output unit 6 may be a display device such as an LCD (Liquid Crystal Display) or CRT (Cathode Ray Tube) or the like.

The transmission/reception unit 7 is a communication interface for performing communication between the server 2 and user terminal 3. For example, upon receiving a transmission request for a digital content file registered in the content data base, from a user terminal 3 via the Internet 4, the transmission/reception unit 7 transmits the received transmission request to the control unit 9. Note that hereinafter, the term “database” will be abbreviated as “DB”. Also, upon receiving the digital content file registered in a later-described content DB 8a from the control unit 9, the transmission/reception unit 7 transmits the received digital content file to the user terminal 3 via the Internet 4.

The storage unit 8 stores various types of information. For example, the storage unit 8 stores the content DB 8a and a dictionary 8b.

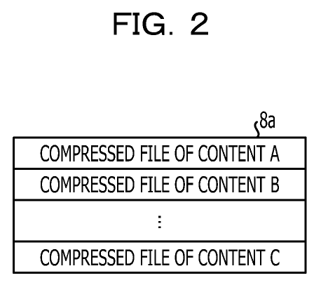

The compressed digital content file is registered in the content DB 8a. For example, the digital content file compressed by a later-described compression unit 9a is registered in the content DB 8a. FIG. 2 is a diagram illustrating an example of the content DB. The example in FIG. 2 illustrates a case wherein each file of compressed digital content A through K have been registered in the content DB 8a. The digital content files registered in the content DB 8a are transmitted to the user terminal 3, according to instructions from the user terminal 3.

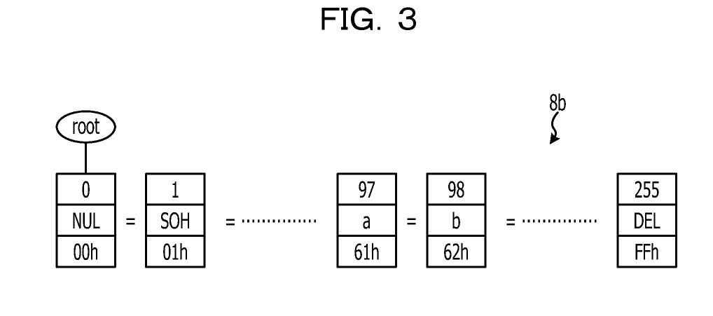

The dictionary 8b is an active dictionary used in a LZ 78 compression method. With the LZ 78 compression method, an active dictionary expressed by a trie is used to perform compression and decompression of a file. Character codes of character and reference numbers are stored in the leaves and nodes of the trie. FIG. 3 is a diagram illustrating an example of a trie. The example in FIG. 3 illustrates an example of a trie illustrating an initialized dictionary 8b. The example in FIG. 3 illustrates a case where 256 types of character codes of “00” to “FF” in hexadecimal, and reference numerals, are registered in the leaves of the trie of the initialized dictionary 8b. The reference numerals are used as compression codes. In the example of FIG. 3, the character code of the character “a” is “97” in decimal. Also, in the example of FIG. 3, the compression code of the character “a” is “61” in hexadecimal. Note that the first row of leaves and nodes connected to the root of the trie are also called a first generation. Similarly, the N'th leaves and nodes of the trie are called the N'th generation. In the first generation leaves and nodes, the character codes and compression codes are the same.

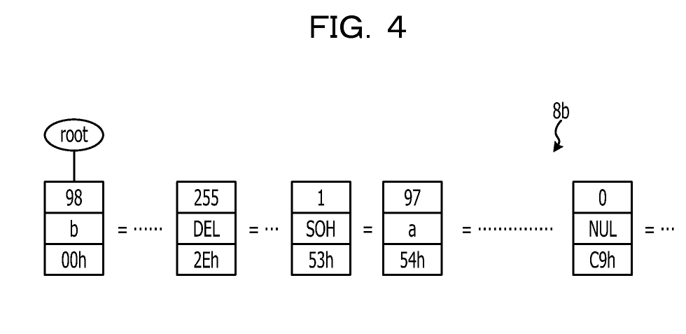

FIG. 4 is a diagram illustrating an example of a case where a first generation compression code of the trie is changed (scrambled). The example in FIG. 4 illustrates a case where the compression code “a” which is “61” in hexadecimal in the example in FIG. 3 is changed to “54” in hexadecimal. The example in FIG. 4 illustrates a case where the compression code “b” which is “62” in hexadecimal in the example in FIG. 3 is changed to “00” in hexadecimal. The first generation compression codes of the trie in the example in FIG. 4 are scrambled by the later-described changing unit 9b, and the combinations of codes and compression codes are changed. Thus, an attacker who attempts to decipher the compressed data, even if understanding the 256 types of combinations of the character codes and compression codes registered in the dictionary 8b at time of initialization, can have difficulty in deciphering the 256 types of characters, since the combinations are changed. In other words, the compression codes corresponding to the codes are encrypted by changing the combination of the codes and the compression codes.

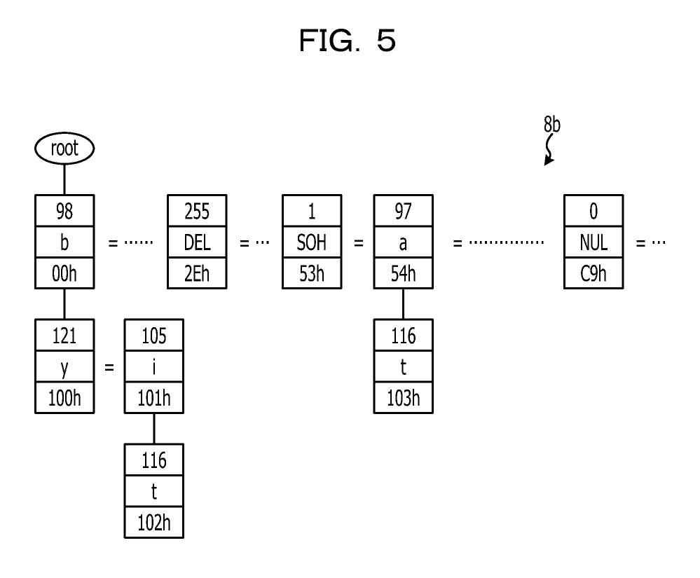

FIG. 5 illustrates an example of a case where leaves and nodes of a second generation and further are added to the trie. In the example in FIG. 5, the reference numeral of the character string “bit” is “102” in hexadecimal. In the example in FIG. 5, compression of the character string “bit” can be performed by using the reference numeral “102” as the compression code of the character string “bit”. Also, in the example in FIG. 5, by replacing the compression file data “102” with the character string “bit”, decompression can be performed.

In the example in FIG. 5, the first generation compression codes are changed, so the data compressed by using compression codes registered in the leaves of the second generation and further is data that is difficult to be deciphered by an attacker or the like. Description will be given with a specific example. For example, let us assume a case of an attacker or the like deciphering the compression character string “bit”. In this case, an attacker or the like, even if understanding the 256 types of combinations of the character codes and compression codes registered in the dictionary 8b at time of initialization, can have difficulty in identifying the compression code “b” which is the first letter of “bit”, since the combinations are changed. That is to say, since it is difficult to identify the storage position of the first letter “b” within the trie, consequently it is difficult for the attacker or the like to identify the compression codes of “bit”.

The storage unit 8 is a semiconductor memory device such as flash memory or a storage apparatus such as a hard disk, optical disk, or the like. Note that the storage unit 8 is not limited to the above-mentioned types of storage apparatuses, and may be RAM (Random Access Memory) or ROM (Read Only Memory).

The control unit 9 has an internal memory to store various types of programs stipulating processing procedures and control data, thereby executing various types of processing. As illustrated in FIG. 1, the control unit 9 has a compression unit 9a and changing unit 9b.

The compression unit 9a uses the dictionary 8b wherein a combination of character codes and compression codes has been modified with the later-described changing unit 9b, and compresses digital content file data input from the input unit 5, while updating the dictionary 8b. Description will be given with a specific example. The compression unit 9a first initializes the dictionary 8b with the LZ78 compression method and registers the combination of predetermined multiple character codes and compression codes. In the example above of FIG. 3, the compression unit 9a registers 256 types of character codes of “00” to “FF” in hexadecimal. The compression unit 9a uses the dictionary 8b wherein a combination of character and compression code has been modified by the changing unit 9b, and compresses the digital content file data with the LZ 78 compression method while updating the dictionary 8b. The compression unit 9a registers the compressed file, for each digital content, in the content DB 8a. Also, upon receiving a transmission request for a digital content file from the user terminal 3, the compression unit 9a obtains the digital content file from the content DB 8a, and transmits the obtained file to the transmission/reception unit 7.

The changing unit 9b changes the combination of character string and compression code of the dictionary 8b in which multiple combinations of character strings and compression codes have been registered, based on the password input from the input unit 5. Description will be given with a specific example. First, the changing unit 9b obtains a password. The changing unit then calculates the sum of the digits, setting “0” through “9” included in the password as hexadecimal “00” through “09”, respectively, and the alphabet letters “a” through “z” as hexadecimal “0A” through “23”. For example, in the case of obtaining “3212” as the password, the changing unit 9b computes “08” (3+2+1+2) in hexadecimal. Next, the changing unit 9b calculates the remainder S in the event of having divided the sum of the digits by a predetermined value. For example, in the case that the sum of the digits is “08” and a predetermined value is “16” in decimal, the changing unit 9b computes the remainder S as “8” (8/16=0 with 8 as the remainder).

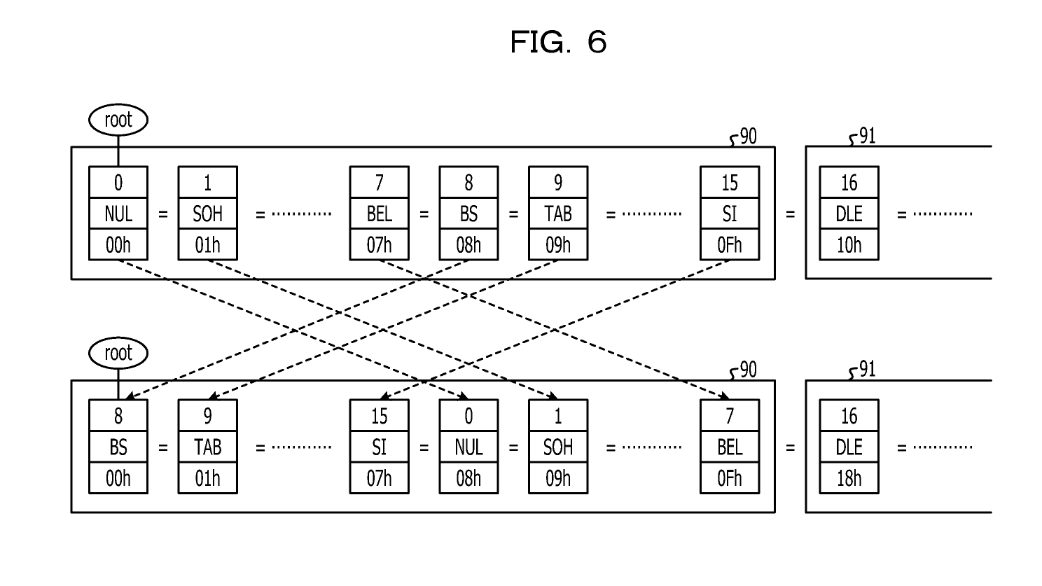

Subsequently, the changing unit 9b blocks the predetermined number of combinations of character and compression codes registered in the dictionary 8b at time of initialization in 2S increments. FIG. 6 is a diagram to describe an example of the processing of the changing unit. The example in FIG. 6 illustrates a case where S=“8”, and the changing unit 9b blocks the combinations of sixteen characters and compression codes every sixteenth combination. In the example in FIG. 6, the first block 90 includes combinations of the codes of each of the 16 characters of “NUL”, “SOH”, . . . “BEL”, “BS”, “TAB”, . . . “SI” and the compression codes. That is to say, in the example in FIG. 6, the first block 90 includes a combination of the code “0” of the characters “NUL” and the compression code “00”. Also, in the example in FIG. 6, the first block 90 includes a combination of the code “1” of the characters “SOH” and the compression code “01”. Also, in the example in FIG. 6, the first block 90 includes a combination of the code “7” of the characters “BEL” and the compression code “07”. Also, in the example in FIG. 6, the first block 90 includes a combination of the code “8” of the characters “BS” and the compression code “08”. Also, in the example in FIG. 6, the first block 90 includes a combination of the code “9” of the characters “TAB” and the compression code “09”. Also, in the example in FIG. 6, the first block 90 includes a combination of the code “15” of the characters “SI” and the compression code “0F”. Further, in the example in FIG. 6, the second block 91 includes a combination of the each of the codes of the sixteen characters of the character “DLE”, . . . , and the compression codes. Thus, the changing unit 9b generates blocks, from the first block to the N'th block. Note that N is an integer derived by rounding up the decimals of the value dividing the number of leaves and nodes of the generation to be processed by 2S. According to the present embodiment, the generation to be processed is the first generation.

Next, the changing unit 9b performs processing such as the following for each block 1 through N. That is to say, the changing unit 9b calculates the remainder S′ in the case of dividing a value adding the remainder S mentioned above to the compression code by the predetermined value mentioned above, for each of the multiple combinations of character code and compression codes in a block. The changing unit 9b changes the compression code to the remainder S′ for each of the multiple combinations of character code and compression codes in a block. In the example in FIG. 6, the remainder S is “8”, so the changing unit 9b changes the compression code of the characters “NUL” to “08” ((“00”+“08”)/predetermined value 16=0 with a remainder of 08). Also, in the example in FIG. 6, the changing unit 9b changes the compression code of the characters “SOH” to “09” ((“01”+“08”)/predetermined value 16=0 with a remainder of 09). Also, in the example in FIG. 6 the changing unit 9b changes the compression code of the characters “BEL” to “0F” ((“07”+“08”)/predetermined value 16=0 with a remainder of 0F). Also, in the example in FIG. 6, the changing unit 9b changes the compression code of the characters “BS” to “10” ((“08”+“08”)/predetermined value 16=1 with a remainder of 00). Also, in the example in FIG. 6, the first block 90 changes the compression code of the characters “TAB” to “01” ((“09”+“08”)/predetermined value 16=1 with a remainder of 01). Also, in the example in FIG. 6, the changing unit 9b changes the compression code of the characters “SI” to “07” ((“0F”+“08”)/predetermined value 16=1 with a remainder of 07). Further, in the example in FIG. 6, the changing unit 9b changes the compression code of the characters “DLE” to “18”. Thus, the changing unit 9b changes the combinations of character strings and compression codes of the dictionary 8b wherein the multiple combinations of character strings and compression codes are registered, based on the password input from the input unit 5 in increments of blocks. Note that the case of the block 1 is exemplified, but the remainder S′ can be calculated for block 2 and above as follows. That is to say, similar to the block 1, for each m(>2) block, the value wherein the value of (m−1)×2S is added to the remainder S′ computed by the above-described division becomes the remainder S′, so that the combinations of character codes and compression codes can be interchanged within the block.

Thus, with the server 2 according to the present embodiment, the compression codes of the first generation leaves and nodes of the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed. Therefore, deciphering a character string that includes the multiple types of characters in the leading character is also difficult.

Also, with the server 2 according to the present embodiment, compression data that is difficult to decipher is generated just by scrambling the compression codes of the dictionary 8b, without performing complicated encryption processing. Accordingly, with the server 2 according to the present embodiment, obfuscating is enabled by simple compression processing. Also, the processing cost increase corresponding to the size increase of the data to be processed can be suppressed.

Also, with the server 2 according to the present embodiment, just by scrambling the compression codes of the dictionary 8b, obfuscating of compression data is readily enabled since scrambling processing is not performed on the compressed data and raw data each time the data is compressed.

The user terminal 3 has an input unit 10, output unit 11, transmission/reception unit 12, storage unit 13, and control unit 14.

The input unit 10 inputs various types of information in the control unit 14. For example, the input unit 10 receives instructions to execute later-described decompression processing from the user, and inputs the received instructions in the control unit 14. Also, the input unit 10 receives a password from the user, and inputs the received password in the control unit 14. Examples of the input unit 10 may be an operation receiving device such as a mouse or keyboard.

The output unit 11 outputs various types of information. For example, the output unit 11 displays playing digital content by a later-described playing unit 14c. Examples of the output unit 11 device may be a display device such as LCD (Liquid Crystal Display) or CRT (Cathode Ray Tube).

The transmission/reception unit 12 is a communication interface to perform communication between the user terminal 3 and server 2. For example, upon receiving a transmission request for a digital content file registered in the content DB from the control unit 14, the transmission/reception unit 12 transmits the received transmission request to the server 2 via the Internet 4. Also, upon receiving the digital content file registered in the content DB 8a from the server 2, the transmission/reception unit 12 transmits the received file to the control unit 14.

The storage unit 13 stores various types of information. For example, the storage unit 13 stores a content DB 13a and dictionary 13b.

Digital content files decompressed by the later-described decompression unit 14a are registered in the content DB 13a.

The dictionary 13b is an active dictionary used in the LZ 78 compression method. Similar to the above-described dictionary 8b, the dictionary 13b, once initialized, by a later-described decompression unit 14a, has multiple combinations of predetermined character codes and compression codes registered therein. Also, the first generation compression codes of the trie indicated by the dictionary 13b are scrambled by the later-described changing unit 14b, similar to the dictionary 8b, and the combinations of codes and compression codes are changed. Thus, an attacker who attempts to decipher the compressed data, even if understanding the 256 types of combinations of the character codes and compression codes registered in the dictionary 13b at time of initialization, can have difficulty in deciphering the 256 types of characters, since the combinations are changed.

Also, similar to the dictionary 8b, after the first generation compression codes of the trie are changed for the dictionary 13b, the leaves and nodes of the second generation trie and further are added by the decompression unit 14a and updated.

The storage unit 13 is a semiconductor memory device such as flash memory or a storage apparatus such as a hard disk, optical disk, or the like. Note that the storage unit 13 is not limited to the above-mentioned types of storage apparatuses, and may be RAM (Random Access Memory) or ROM (Read Only Memory).

The control unit 14 has an internal memory to store programs stipulating various types of processing procedures, and control data, whereby various types of processing are executed. As illustrated in FIG. 1, the control unit 14 includes the decompression unit 14a, changing unit 14b, and playing unit 14c.

The decompression unit 14a uses the dictionary 13b wherein the combinations of the character codes and compression codes have been changed by the later-described changing unit 14b, and updates the dictionary 13b while decompressing the digital content file data input by the server 2. Description will be given with a specific example. The decompression unit 14a first initializes the dictionary 13b using the LZ 78 compression method, and registers the predetermined multiple combinations of character codes and compression codes. Now, at the time of initializing the dictionary 13b, the decompression unit 14a registers the same combinations as the combinations of character and compression codes registered in the dictionary 8a when the dictionary 8a had been initialized by the compression unit 9a. The decompression unit 14a uses the dictionary 13b wherein the combinations of character and compression codes have been changed by the changing unit 14b, and updates the dictionary 13b while decompressing the digital content file data by the LZ 78 compression method. The decompression unit 14a registers the decompressed file in the content DB 13a, for each digital contents.

The changing unit 14b changes the combinations of character strings and compression codes in the dictionary 13b, wherein multiple combinations of character strings and compression codes have been registered, based on the password input from the input unit 10. Description will be given with a specific example. First, the changing unit 14b obtains a password. Then similar to the changing unit 9a, the changing unit 14b calculates the sum of the digits, setting the numbers “0” through “9” included in the password as hexadecimal “00” through “09”, respectively, and the alphabet letters “a” through “z” as hexadecimal “0A” through “23”, respectively.

Subsequently, the changing unit 14b blocks the predetermined number of combinations of character and compression codes registered in the dictionary 13b at time of initialization in 2S increments, similar to the changing unit 9a. The example in FIG. 6 illustrates a case where S=“8”, and the changing unit 14b blocks the combinations of sixteen characters and compression codes every sixteenth combination. The changing unit 14b generates blocks, from the first block to the N'th block. Note that N is an integer derived by rounding up the decimals of the value dividing the number of leaves and nodes of the generation to be processed by 2S. According to the present embodiment, the generation to be processed is the first generation.

Next, the changing unit 14b performs processing such as the following for each block 1 through N. That is to say, similar to the changing unit 9a, the changing unit 14b calculates the remainder S′ in the case of dividing a value adding the remainder S to the compression code by the predetermined value mentioned above, for each of the multiple combinations of character codes and compression codes in a block. The changing unit 9b changes the compression code to the remainder S′ for each of the multiple combinations of character codes and compression codes in a block. In the example in FIG. 6, the remainder S is “8”, so the changing unit 14b changes the compression code of the characters “NUL” to “08” ((“00”+“08”)/predetermined value 16=0 with a remainder of 08). Also, in the example in FIG. 6, the changing unit 14b changes the compression code of the characters “SOH” to “09” ((“01”+“08”)/predetermined value 16=0 with a remainder of 09). Also, in the example in FIG. 6 the changing unit 14b changes the compression code of the characters “BEL” to “0F” ((“07”+“08”)/predetermined value 16=0 with a remainder of 0F). Also, in the example in FIG. 6, the changing unit 14b changes the compression code of the characters “BS” to “10” ((“08”+“08”)/predetermined value 16=1 with a remainder of 00). Also, in the example in FIG. 6, the first block 90 changes the compression code of the characters “TAB” to “01” ((“09”+“08”)/predetermined value 16=1 with a remainder of 01). Also, in the example in FIG. 6, the changing unit 14b changes the compression code of the characters “SI” to “07” ((“0F”+“08”)/predetermined value 16=1 with a remainder of 07). Further, in the example in FIG. 6, the changing unit 14b changes the compression code of the characters “DLE” to “18”. Thus, the changing unit 14b changes the combinations of character strings and compression codes of the dictionary 13b wherein the multiple combinations of character strings and compression codes are registered, based on the password input from the input unit 10, in increments of blocks. Note that the case of the block 1 is exemplified, but the remainder S′ can be calculated for block 2 and above as follows. That is to say, similar to the block 1, for each m(>2) block, the value wherein the value of (m−1)×2S is added to the remainder S′ computed by the above-described division becomes the remainder S′, so that the combinations of character codes and compression codes can be interchanged within the block.

Now, with the user terminal 3 according to the present embodiment, in the case that the input password does not match the correct password input by the server 2, the greater the above-mentioned predetermined value is, the lower the probability is that the calculated remainder S will match the remainder S calculated by the server 2. Therefore, with the user terminal 3 according to the present embodiment, in the case that the input password is not the correct password, the greater the above-mentioned predetermined value is, the lower the probability is that the registration content of the dictionary 13b will match the registration content of the dictionary 8b. Therefore, with the user terminal 3 according to the present embodiment, the probability that the decompressed data will be correct also decreases resultantly. Accordingly, with the user terminal 3 according to the present embodiment, obfuscation can be readily enabled.

The playing unit 14c obtains the digital content registered in the content DB 13a, and plays the obtained digital content on the display device of the output unit 11.

The control unit 14 has an integrated circuit such as ASIC (Application Specific Integrated Circuit) or FPGA (Field Programmable Gate Array). Note that the control unit 14 may have an electronic circuit such as a CPU (Central Processing Unit) or MPU (Micro Processing Unit).

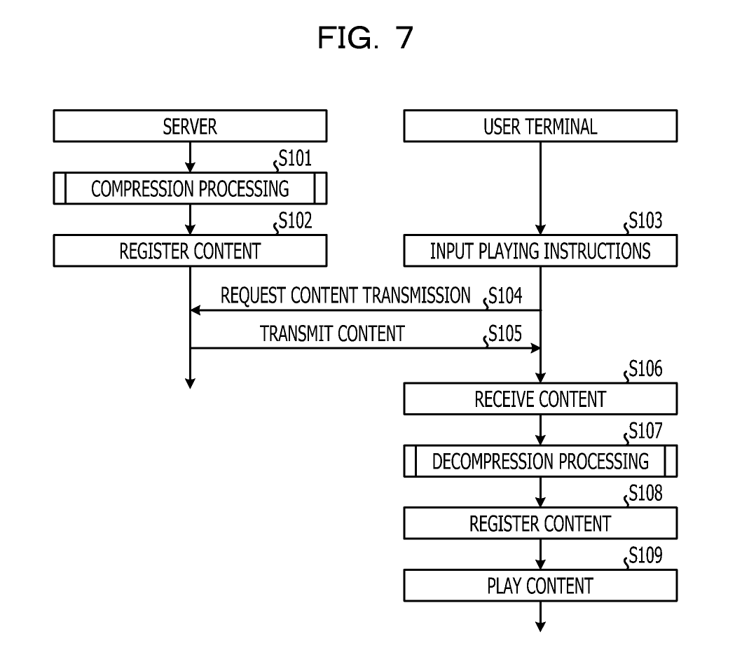

Next, the processing flow of the system 1 according to the present embodiment will be described. FIG. 7 is a sequence diagram of the system according to the first embodiment.

As illustrated in FIG. 7, the server 2 executes later-described compression processing (S101). The server 2 registers the compressed digital content file in the content DB 8a (S102).

On the other hand, upon receiving instructions from the user to execute the later-described decompression processing (S103), the user terminal 3 transmits the digital content file transmission request to the server 2 (S104). Upon receiving the digital content file transmission request, the server 2 transmits the digital content file registered in the content DB 8a to the user terminal 3 (S105).

Upon receiving the digital content file (S106), the user terminal 3 executes the later-described decompression processing (S107). The user terminal 3 registers the decompressed digital content file in the content DB 13a (S108). The user terminal 3 plays the digital content registered in the content DB 13a (S109).

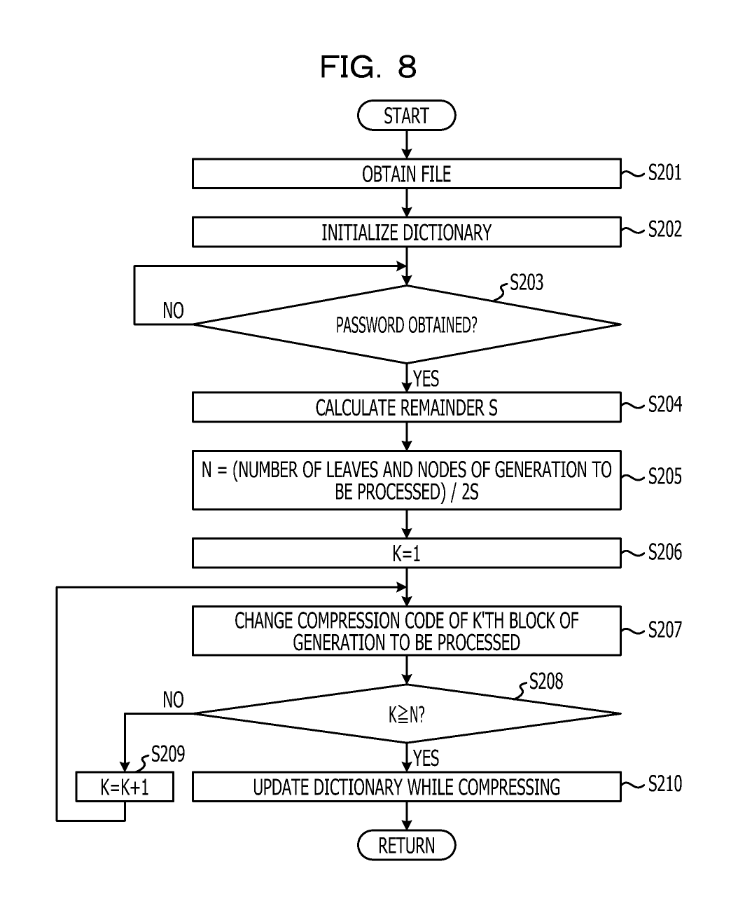

Next, a processing flow of the server 2 according to the present embodiment will be described. FIG. 8 is a flowchart illustrating the procedures of the compression processing according to the first embodiment. Various timings may be considered for the execution timing of the compression processing. For example, the compression processing may be executed in the case that the digital content is input from the input unit 5.

As illustrated in FIG. 8, the compression unit 9a obtains the digital content file (S201). The compression unit 9a initializes the dictionary 8b (S202). The changing unit 9b determines whether or not a password has been input by the input unit 5 (S203). In the case that a password has not been input (No in S203), the changing unit 9b determines again in S203 whether or not a password has been input from the input unit 5.

On the other hand, in the case that a password is input (Yes in S203), the changing unit 9b calculates the sum of the digits of the password, and calculates the remainder S in the case of dividing the calculated sum by the predetermined value (S204). The changing unit 9b calculates an integer N derived by rounding up the decimals of the value dividing the number of leaves and nodes of the generation to be processed by 2S (S205). The changing unit 9b sets 1 as the value of a variable K (S206). The changing unit 9b scrambles the compression codes of the K'th block of the generation to be processed, and changes the combinations of character codes and compression codes (S207). The changing unit 9b determines whether or not the value of the variable K is the integer value N or greater (S208). In the case that the value of the variable K is less than the integer value N (No in S208), the changing unit 9b increments the value of the variable K by 1 (S209), and returns to S207.

On the other hand, in the case that the value of the variable K is the integer value N or greater (Yes in S208), the compression unit 9a uses the dictionary 8b, and updates the dictionary 8b while compressing the digital content file data with the LZ 78 compression method (S210). The compression unit 9a stores the processing results in the internal memory of the control unit 9, and returns.

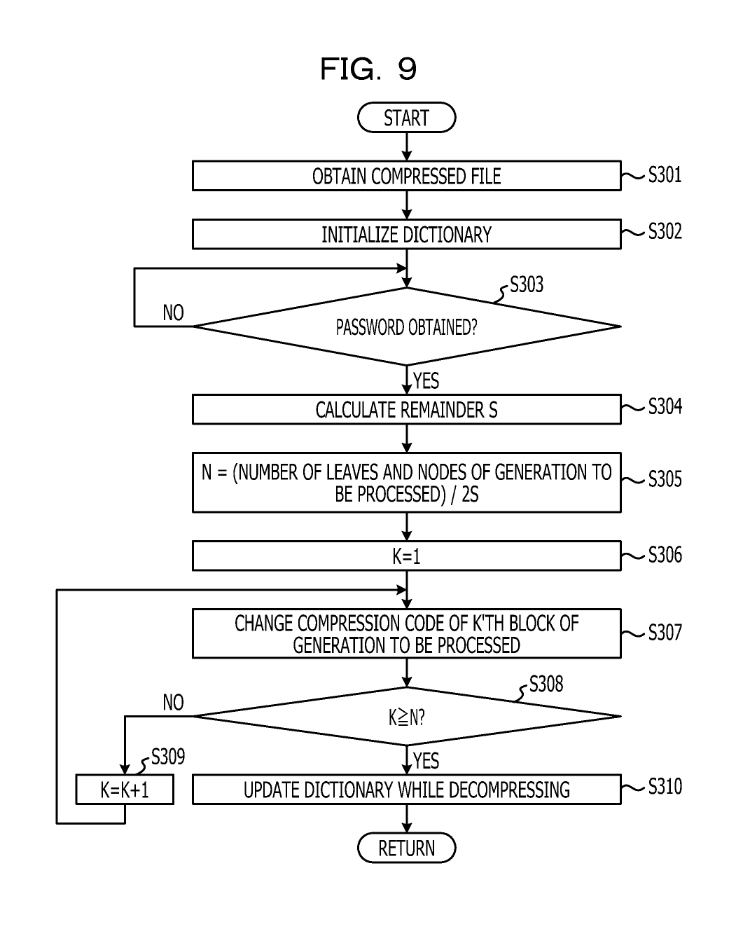

Next, a processing flow of the user terminal 3 according to the present embodiment will be described. FIG. 9 is a flowchart illustrating the procedures of the decompression processing according to the first embodiment. With the decompression processing also, the dictionary updating algorithm that is common to the compression processing described in FIG. 8 is used.

As illustrated in FIG. 9, the decompression unit 14a obtains a compressed file of digital content from the server 2 (S301). The decompression unit 14a initializes the dictionary 13b (S302). The changing unit 14b determines whether or not a password has been input by the input unit 10 (S303). In the case that a password has not been input (No in S303), the changing unit 14b determines again in S303 whether a password has been input by the input unit 10.

On the other hand, in the case that a password has been input (Yes in S303), the changing unit 14b calculates the sum of the digits of the password, and calculates the remainder S in the case of dividing the calculated sum by the predetermined value (S304). The changing unit 14b calculates an integer N derived by rounding up the decimals of the value dividing the number of leaves and nodes of the generation to be processed by 2S (S305). The changing unit 14b sets 1 as the value of a variable K (S306). The changing unit 14b scrambles the compression codes of the K'th block of the generation to be processed, and changes the combinations of character codes and compression codes (S307). The changing unit 14b determines whether or not the value of the variable K is the integer value N or greater (S308). In the case that the value of the variable K is less than the integer value N (No in S308), the changing unit 14b increments the value of the variable K by 1 (S309), and returns to S307.

On the other hand, in the case that the value of the variable K is the integer value N or greater (Yes in S308), the decompression unit 14a uses the dictionary 13b, and updates the dictionary 13b while decompressing the digital content file data with the LZ 78 compression method (S310). The decompression unit 14a stores the processing results in the internal memory of the control unit 14, and returns.

As described above, with the server 2 according to the present embodiment, the compression codes of the first generation leaves and nodes in the dictionary 8b are scrambled, and combinations of the codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed. Therefore, deciphering a character string that includes the multiple types of characters in the leading character is also difficult.

Also, with the server 2 according to the present embodiment, compression data that is difficult to decipher is generated just by scrambling the compression codes of the dictionary 8b, without performing complicated encryption processing. Accordingly, with the server 2 according to the present embodiment, obfuscating is enabled by simple compression processing. Also, the processing cost increase corresponding to the size increase of the data to be processed can be suppressed.

Also, with the server 2 according to the present embodiment, just by scrambling the compression codes of the dictionary 8b, obfuscating of compression data is readily enabled, since scrambling processing is not performed on the compressed data and raw data each time the data is compressed.

Also, with the user terminal 3 according to the present embodiment, in the case that the input password does not match the correct password input by the server 2, the greater the above-mentioned predetermined value is, the lower the probability is that the calculated remainder S will match the remainder S calculated by the server 2. Therefore, with the user terminal 3 according to the present embodiment, in the case that the input password is not the correct password, the greater the above-mentioned predetermined value is, the lower the probability is that the registration content of the dictionary 13b will match the registration content of the dictionary 8b. Therefore, with the user terminal 3 according to the present embodiment, the probability that the decompressed data will be correct also decreases. Accordingly, with the user terminal 3 according to the present embodiment, obfuscation can be readily enabled.

Next, a second embodiment will be described.

In the first embodiment described above, a case of scrambling the first generation compression codes is exemplified, but the apparatus disclosed is not limited to this. Thus, in the second embodiment, a case of also scrambling the compression codes of the second generation and thereafter will be described.

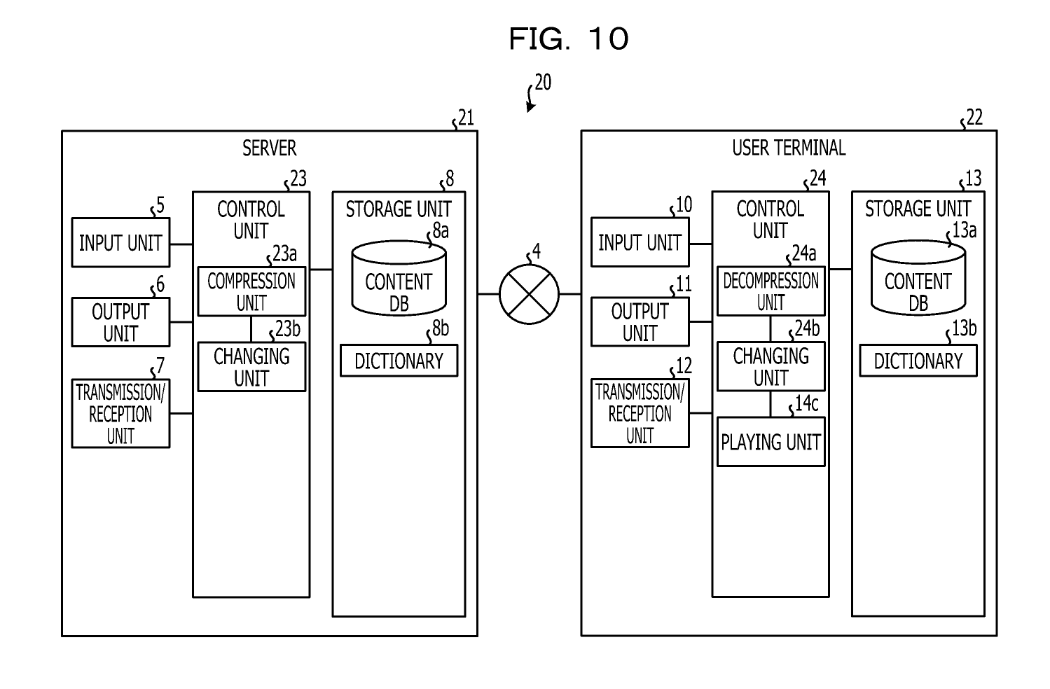

A system according to the second embodiment will be described. FIG. 10 is a diagram illustrating an example of a system configuration according to the second embodiment. A system 20 according to the present embodiment has a server 21 and user terminal 22. The server 21 differs from the first embodiment in having a control unit 23 instead of the control unit 9 according to the first embodiment. The user terminal 22 differs from the first embodiment in having a control unit 24 instead of the control unit 14 according to the first embodiment. Now, in the description below, there are cases where the same reference numerals as in FIG. 1 denote parts and devices that perform similar functions to the first embodiment, and descriptions thereof are omitted. The server 21 compresses digital content file data such as a dictionary or electronic book. The server 21 transmits the compressed digital content file data to the user terminal 22 via the Internet 4. The user terminal 22 decompresses the received digital content file data. The user terminal 22 plays the decompressed digital content file.

The server 21 has an input unit 5, output unit 6, transmission/reception unit 7, storage unit 8, and control unit 23.

The control unit 23 has an internal memory to store various types of programs stipulating processing procedures and control data, thereby executing various types of processing. As illustrated in FIG. 10, the control unit 23 has a compression unit 23a and changing unit 23b.

The compression unit 23a performs processing similar to the compression unit 9a according to the first embodiment. That is to say, the compression unit 23a uses the dictionary 8b wherein a combination of character codes and compression codes has been modified with the later-described changing unit 23b, and compresses digital content file data. Also, the compression unit 23a newly registers combinations of character strings that include compressed character strings before the character strings had been compressed and that are unregistered in the dictionary 8b, and compression codes, in the dictionary 8b.

The changing unit 23b performs processing similar to the changing unit 9b according to the first embodiment. Further, the changing unit 23b newly changes the combinations of characters strings and compression codes newly registered in the dictionary 8b, based on the password. Description will be given with a specific example.

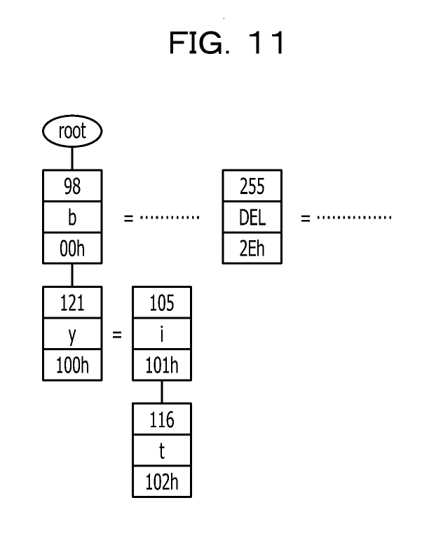

The changing unit 23b identifies the generation of the newly added characters, of the characters in the newly registered character string, as the generation to be processed, each time a combination of character strings and compression codes is registered in the dictionary 8b. FIG. 11 is a diagram to describe an example of processing executed by the system according to the second embodiment. The example in FIG. 11 illustrates a case of the combination of the code “98105116” of the character string “bit” and the compression code “102” being registered in the dictionary 8b. In the example in FIG. 11, upon the combination of the unregistered code and compression code of the character string “but” being newly registered by the compression unit 23a, the changing unit 23b identifies the second generation of the “u” in “but” and the third generation of “t” as the generations to be processed.

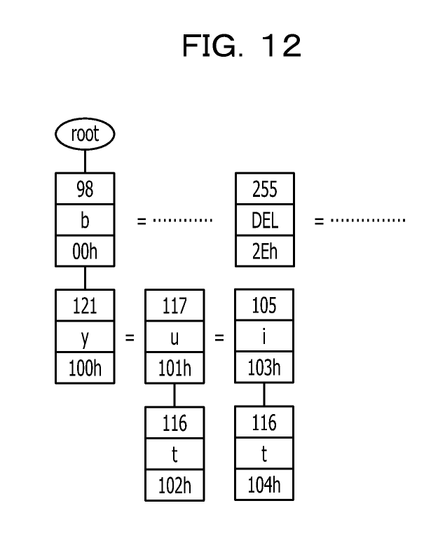

The changing unit 23b changes the identified combination of character strings and compression codes to be processed with a method similar to the method by which the changing unit 9b according to the first embodiment changed the combination between the first generation character string and compression code registered in the dictionary 8b. FIG. 12 is a diagram to describe an example of processing executed by the system according to the second embodiment. The example in FIG. 12 illustrates an example of processing by the changing unit 23b in a case that the combination of the unregistered code and compression code of the character string “but” being newly registered in the dictionary 8b in the example in FIG. 11 is newly registered in the dictionary 8b by the compression unit 23a. In the example in FIG. 12, the changing unit 23b changes the compression codes of each of the second generation character “u” and third generation character “t” of the character string “but”, and the compression codes of each of the second generation character “i” and third generation character “t” of the character string “bit”. That is to say, in the example in FIG. 12, the changing unit 23b changes the compression code corresponding to the second generation character “u” of the character string “but” to “101”, and changes the compression code corresponding to the third generation character “t” to “102”. Also, in the example in FIG. 12, the changing unit 23b changes the compression code corresponding to the second generation character “i” of the character string “bit” to “103”, and changes the compression code corresponding to the third generation character “t” to “104”. Note that in order for the combinations of character codes and compression codes to be interchanged within the block, the value corresponding to the compression code within the block is added to the remainder S′, and the remainder S′ obtained as a result of the addition is combined with the character string.

Thus, with the server 21 according to the present embodiment, the compression codes of the leaves and nodes of the first generation in the dictionary 8b and the generation of characters newly added to the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed.

Also, with the server 21 according to the present embodiment, compression data that is difficult to decipher is generated just by scrambling the compression codes of the dictionary 8b, without performing complicated encryption processing. Accordingly, with the server 21 according to the present embodiment, obfuscating is enabled by simple compression processing. Also, the processing cost increase corresponding to the size increase of the data to be processed can be suppressed.

Also, with the server 21 according to the present embodiment, just by scrambling the compression codes of the dictionary 8b, obfuscating of compression data is readily enabled since scrambling processing is not performed on the compressed data and raw data each time the data is compressed.

The user terminal 22 has an input unit 10, output unit 11, transmission/reception unit 12, storage unit 13, and control unit 24.

The control unit 24 has an internal memory to store various types of programs stipulating processing procedures and control data, thereby executing various types of processing. As illustrated in FIG. 10, the control unit 24 has a decompression unit 24a, changing unit 24b, and playing unit 14c.

The decompression unit 24a performs processing similar to the decompression unit 14a according to the first embodiment. That is to say, the decompression unit 24a uses the dictionary 13b wherein a combination of character codes and compression codes has been modified with the later-described changing unit 24b, to decompress digital content file data. Also, the decompression unit 24a newly registers combinations of character strings that include decompressed characters and that are unregistered in the dictionary 13b, and compression codes, in the dictionary 13b.

The changing unit 24b performs processing similar to the changing unit 14b according to the first embodiment. Further, the changing unit 24b newly changes the combinations of characters strings and compression codes newly registered in the dictionary 13b, based on the password. Description will be given with a specific example.

Of the characters in the newly registered character string, the changing unit 24b identifies the generation of the newly added characters as the generation to be processed, each time a combination of character strings and compression codes is newly registered in the dictionary 13b. For example, in the case that the combination of codes and compression codes of the character string “bit” is registered in the dictionary 13b, if the combination of codes and compression codes of an unregistered character string “but” is registered more newly by the decompression unit 24a, the changing unit 24b performs processing as follows. That is to say, the changing unit 24b identifies the second generation of the “u” in “but” and the third generation of “t” as the generations to be processed.

The changing unit 24b changes the identified combination of character strings and compression codes of the generation to be processed, similar to the changing unit 14b changing the combination between the first generation character string and compression code registered in the dictionary 13b according to the first embodiment. For example, in the case that the combination of codes and compression codes of the character string “bit” is registered in the dictionary 13b, if the combination of codes and compression codes of an unregistered character string “but” is registered more newly by the decompression unit 24a, the changing unit 24b performs processing as follows. That is to say, the changing unit 24b changes the compression codes of each of the second generation character “u” and third generation character “t” of the character string “but”, and changes the compression codes of each of the second generation character “i” and third generation character “t” of the character string “bit”. Note that in order for the combinations of character codes and compression codes to be interchanged within the block, the value corresponding to the compression code within the block is added to the remainder S′, and the remainder S′ obtained as a result of the addition is combined with the character string.

Thus, with the user terminal 22 according to the present embodiment, in the case that the input password does not match the correct password input by the server 21, the greater the above-mentioned predetermined value is, the lower the probability is that the calculated remainder S will match the remainder S calculated by the server 21. Therefore, with the user terminal 22 according to the present embodiment, in the case that the input password is not the correct password, the greater the above-mentioned predetermined value is, the lower the probability is that the registration content of the dictionary 13b will match the registration content of the dictionary 8b. Therefore, with the user terminal 22 according to the present embodiment, the probability that the decompressed data will be correct also decreases resultantly. Accordingly, with the user terminal 22 according to the present embodiment, obfuscation can be readily enabled.

The control unit 24 has an integrated circuit such as ASIC (Application Specific Integrated Circuit) or FPGA (Field Programmable Gate Array). Note that the control unit 24 may have an electronic circuit such as a CPU (Central Processing Unit) or MPU (Micro Processing Unit).

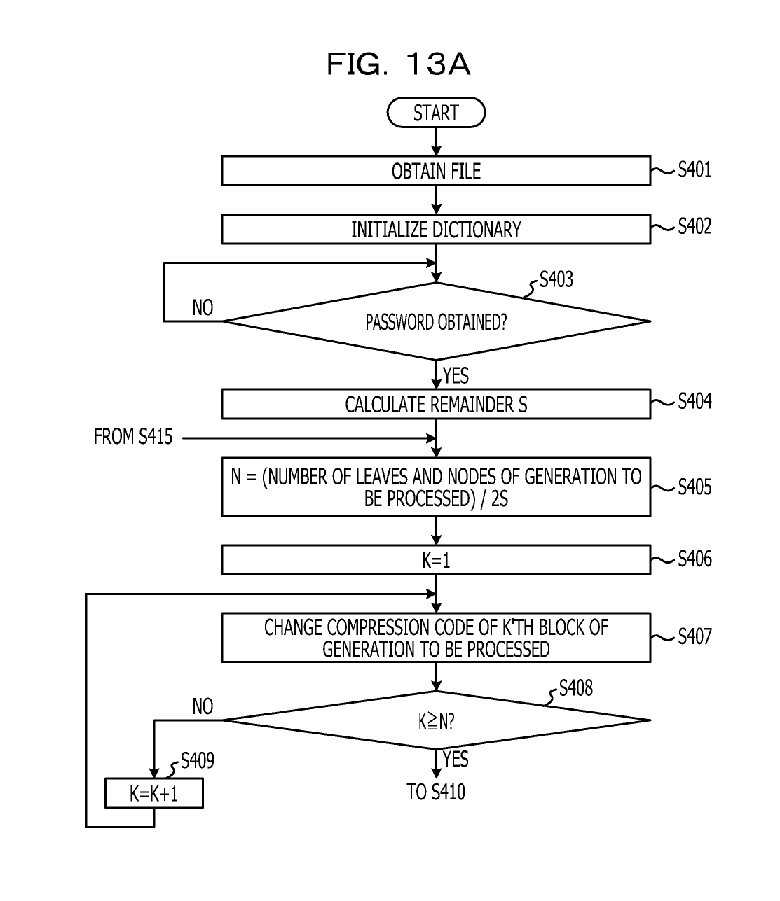

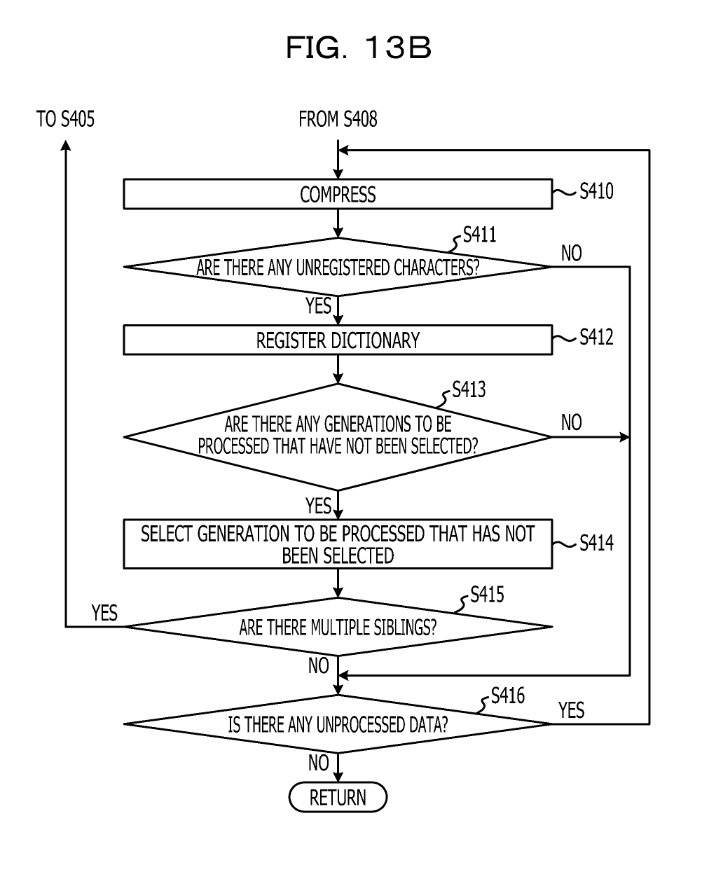

Next, a processing flow of the server 21 according to the present embodiment will be described. FIG. 13 is a flowchart illustrating the procedures of the compression processing according to the second embodiment. Various timings may be considered for the execution timing of the compression processing. For example, the compression processing may be executed in the case that the digital content is input from the input unit 5. Note that the processing flow of the system 20 according to the present embodiment is similar to the processing flow illustrated in the sequence diagram of the system 1 according to the first embodiment, so the description will be omitted.

The steps S401 through S409 described in FIG. 13 are similar to the steps S201 through S209 described in FIG. 8, so the description thereof will be omitted. As illustrated in FIG. 13, the compression unit 23a uses the dictionary 8b and compresses unprocessed data of a digital content file (S410). The compression unit 23a determines whether or not, of the character strings indicated by the digital content file, the codes of the character string that include the character string of the portion compressed this time in the lead portion are unregistered in the dictionary 8b (S411). In the case the codes are unregistered (Yes in S411), the compression unit 23a newly registers combinations of character strings that include compressed character strings before the character strings had been compressed and that are unregistered in the dictionary 8b, and compression codes, in the dictionary 8b (S412). On the other hand, in the case that the codes are not unregistered (No in S411), the compression unit 23a determines, of the digital content file data, whether there is any data that has not been subjected to compression processing (S416). In the case there is data that has not been subjected to compression processing (Yes in S416), the flow is returned to S410. In the case there is no data that has not been subjected to compression processing (No in S416), the compression unit 23a stores the processing result in the internal memory of the control unit 23, and returns.

The changing unit 23b identifies the generation of the newly added characters, of the characters in the character string newly registered in the dictionary 8b, as the generation to be processed, and determines whether, of the identified generations to be processed, there are any generations to be processed that are not selected in the S414 below (S413). In the case there are generations to be processed that have not been selected (Yes in S413), the changing unit 23b selects one of the generations to be processed that has not been selected (S414). The changing unit 23b determines whether or not there are multiple numbers of leaves and nodes of the selected generation to be processed (S415). In the case there are multiple numbers (Yes in S415), the flow is returned to S405.

On the other hand, in the case there are no generations to be processed that have not been selected (No in S413), or in the case there are not multiple numbers (No in S415), the flow is advanced to S416.

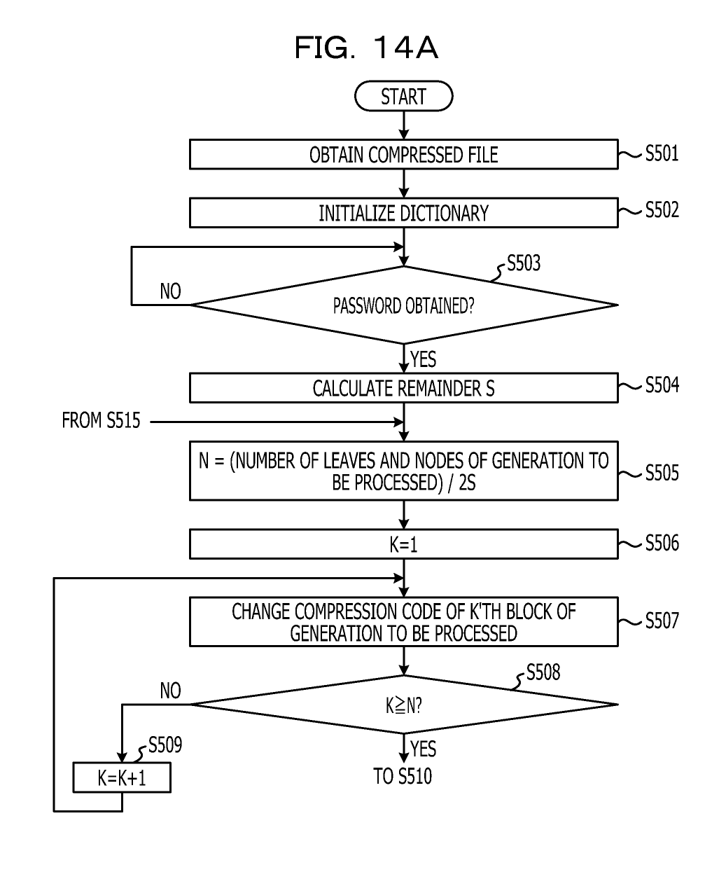

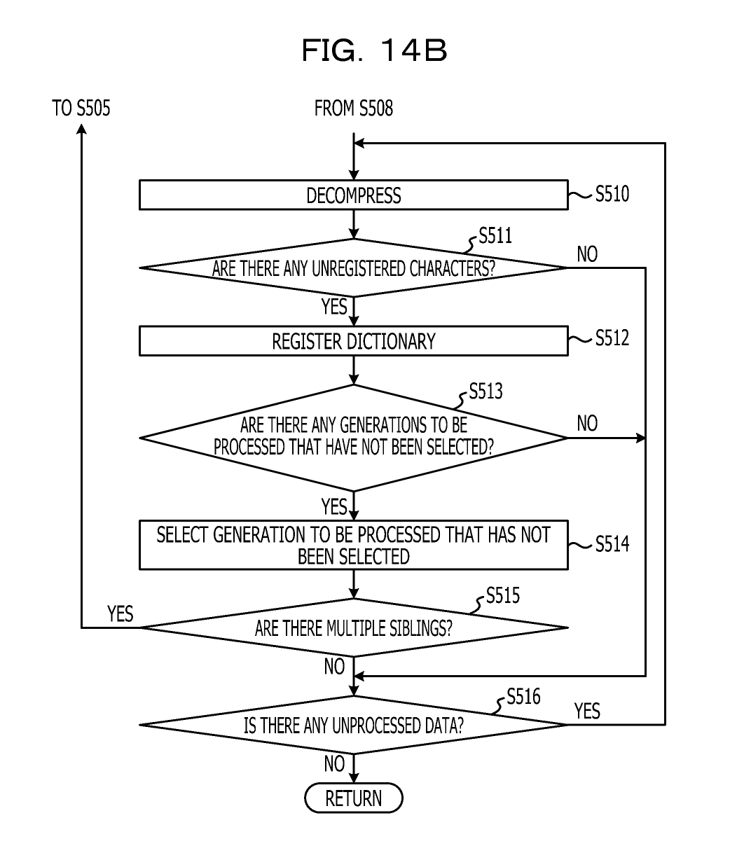

Next, a processing flow of the user terminal 22 according to the present embodiment will be described. FIG. 14 is a flowchart illustrating procedures of the decompression processing according to the second embodiment. The steps S501 through S509 in FIG. 14 are similar to the steps S301 through S309 in FIG. 9, so the description thereof will be omitted. As illustrated in FIG. 14, the decompression unit 24a uses the dictionary 13b and decompresses unprocessed data of the digital content file (S510). The decompression unit 24a determines whether or not the codes of the character string that include the character string decompressed this time included in the lead portion are unregistered in the dictionary 13b (S511). In the case there are unregistered codes (Yes in S511), the decompression unit 24a newly registers, in the dictionary 13b, a combination of the character string codes that are character strings including the decompressed character string and that are unregistered in the dictionary 13b (S512). On the other hand, in the case the codes are not unregistered (No in S511), the decompression unit 24a determines whether or not there is any data, of the digital content file data, not subjected to compression processing (S516). In the case there is data not subjected to compression processing (Yes in S516), the flow is returned to S510. In the case there is no data not subjected to compression processing (No in S516), the decompression unit 24a stores the processing result in the internal memory of the control unit 24, and returns.

The changing unit 24b identifies the generation of the newly added characters, of the characters in the newly registered character string in the dictionary 13b as the generation to be processed, and determines whether, of the identified generations to be processed, there are any generations to be processed that are not selected in the S514 below (S513). In the case there are generations to be processed that have not been selected (Yes in S513), the changing unit 24b selects one of the generations to be processed that has not been selected (S514). The changing unit 24b determines whether or not there are multiple numbers of leaves and nodes of the selected generation to be processed (S515). In the case there are multiple numbers (Yes in S515), the flow is returned to S505.

On the other hand, in the case there are no generations to be processed that have not been selected (No in S513), or in the case there are not multiple numbers (No in S515), the flow is advanced to S516.

As described above, with the server 21 according to the present embodiment, the compression codes of the first generation in the dictionary 8b and the generation of the newly added characters of the character string newly registered in the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed.

Also, with the server 21 according to the present embodiment, compression data that is difficult to decipher is generated just by scrambling the compression codes of the dictionary 8b, without performing complicated encryption processing. Accordingly, with the server 21 according to the present embodiment, obfuscating is enabled by simple compression processing.

Also, with the server 21 according to the present embodiment, just by scrambling the compression codes of the dictionary 8b, obfuscating of compression data is readily enabled since scrambling processing is not performed on the compressed data and raw data each time the data is compressed.

Also, with the user terminal 22 according to the present embodiment, in the case that the input password does not match the correct password input by the server 21, the greater the above-mentioned predetermined value is, the lower the probability is that the calculated remainder S will match the remainder S calculated by the server 21. Therefore, with the user terminal 22 according to the present embodiment, in the case that the input password is not the correct password, the greater the above-mentioned predetermined value is, the lower the probability is that the registration content of the dictionary 13b will match the registration content of the dictionary 8b. Therefore, with the user terminal 22 according to the present embodiment, the probability that the decompressed data will be correct also decreases resultantly. Accordingly, with the user terminal 22 according to the present embodiment, obfuscation can be readily enabled.

Next, a third embodiment will be described.

In the first and second embodiments described above, cases of changing the combinations of character codes and compression codes registered in the dictionaries 8b and 13b, according to the remainder value in the case of dividing a value indicated by the password by a predetermined value, is exemplified, but the apparatus disclosed is not limited to this. Thus, in the third embodiment, a case of changing the combinations of characters and compression codes registered in the dictionaries 8b and 13b with another method will be described. According to the third embodiment, a first value of a predetermined length is generated from a password, using a first hash function, and a second value is generated from the first value, using a second hash function. Also according to the third embodiment, the combination of the character and compression codes registered in the dictionaries 8b and 13b are changed according to the second value.

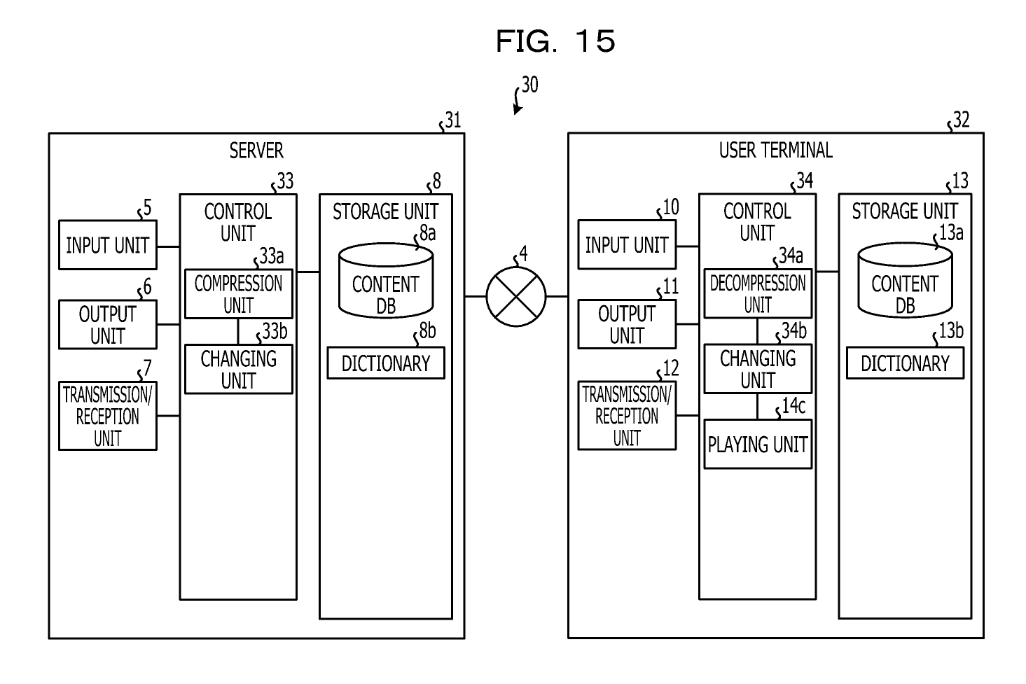

A system according to the third embodiment will be described. FIG. 15 is a diagram illustrating an example of a system configuration according to the third embodiment. A system 30 according to the present embodiment has a server 31 and user terminal 32. The server 31 differs from the first embodiment in having a control unit 33 instead of the control unit 9 according to the first embodiment. The user terminal 32 differs from the first embodiment in having a control unit 34 instead of the control unit 14 according to the first embodiment. Now, in the description below, there are cases where the same reference numerals are appended as in FIGS. 1 and 10 for parts and devices that perform similar functions to the first and second embodiments, and descriptions thereof are omitted. The server 31 compresses digital content file data such as a dictionary or electronic book. The server 31 transmits the compressed digital content file data to the user terminal 32 via the Internet 4. The user terminal 32 decompresses the received digital content file data. The user terminal 32 plays the decompressed digital content file.

The server 31 has an input unit 5, output unit 6, transmission/reception unit 7, storage unit 8, and control unit 33.

The control unit 33 has an internal memory to store various types of programs stipulating processing procedures and control data, thereby executing various types of processing. As illustrated in FIG. 15, the control unit 33 has a compression unit 33a and changing unit 33b.

The compression unit 33a performs processing similar to the compression unit 9a according to the first embodiment. That is to say, the compression unit 33a uses the dictionary 8b wherein a combination of character codes and compression codes has been modified with the later-described changing unit 33b, and compresses digital content file data. Also, the compression unit 33a newly registers, in the dictionary 8b, combinations of character strings that include compressed characters before the characters had been compressed and that are unregistered in the dictionary 8b, and compression codes.

The changing unit 33b changes the combinations of character strings and compression codes in the dictionary 8b in which multiple combinations of character strings and compression codes are registered, based on the password input from the input unit 5. The following is a specific example. First, the changing unit 33b obtains a password. The changing unit 33b then uses a first hash function such as SHA (Secure Hash Algorithm)-256 or the like, using the password as a seed, and obtains as a seed a hash value of a predetermined length to be used for the next second hash function. Next, the change unit 33b further uses a second hash function, and obtains a hash value from the seed. Thus, generating a seed from the password using the first hash function is to obtain a seed of a sufficiently long predetermined length to be used for the second hash function. An example of a second hash function may be a function to cause pseudorandom numbers to occur. A function to cause pseudorandom numbers to occur will be described as an example of the second hash function.

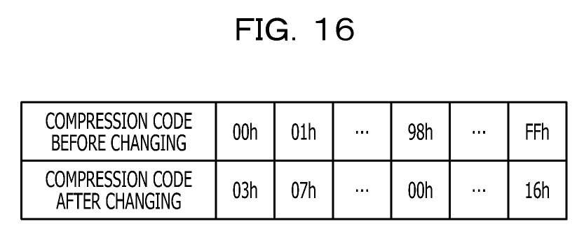

Subsequently, the changing unit 33b correlates the value of “00” in hexadecimal as the compression code before changing, and the hash value (pseudorandom number) as the compression code after changing, and stores this in the storage unit 8. FIG. 16 is a diagram illustrating an example of information stored in the storage unit. The example in FIG. 16 illustrates a case where the changing unit 33b correlates the value of “00” in hexadecimal as the compression code before changing, and the hash value “03” (hexadecimal) as the compression code after changing, and stores this in the storage unit 8.

Next, the changing unit 33b obtains the hash value from the seed, using the second hash function again. The changing unit 33b then determines whether or not the obtained hash value is registered in the storage unit 8 as the compression code after changing. In the case that the obtained hash value is registered in the storage unit 8 as the compression code after changing, the changing unit 33b performs processing such as the following. That is to say, the changing unit 33b repeatedly performs incrementing the obtained hash value by 1 and determining whether or not the hash value is registered in the storage unit 8 as the compression code after changing, until a negative determination is made. In the case that the hash value is not registered in the storage unit 8 as the compression code after changing, the changing unit 33b correlates the value of “01” in hexadecimal as the compression code before changing, and the hash value as the compression code after changing, and stores this in the storage unit 8. The example in FIG. 16 illustrates a case where the changing unit 33b correlates the value of “01” in hexadecimal as the compression code before changing, and the hash value “07” (hexadecimal) as the compression code after changing, and stores this in the storage unit 8.

The changing unit 33b repeatedly performs such processing for the multiple character compression codes that have been registered in the dictionary 8b at time of initialization. For example, in the case that compression codes for 256 types of characters from “00” to “FF” in hexadecimal are registered in the dictionary 8b at time of initialization, the changing unit 33b handles the 256 compression codes from “00” to “FF” as the compression codes before changing. Also, then changing unit 33b generates compression codes after changing, as to each of the compression codes before changing, correlates the compression codes before changing and the compression codes after changing, and stores these in the storage unit 8.

The changing unit 33b changes each of the compression codes registered in the dictionary 8b at time of initialization into the corresponding compression codes after changing, respectively. For example, in the example in FIG. 16, the changing unit 33b changes the compression code of the character having a compression code of “00” into “03”. Also, in the example in FIG. 16, the changing unit 33b changes the character having a compression code of “01” into “07”. Thus, the changing unit 33b changes the combination of the character strings and compression codes in the dictionary 8b wherein multiple combinations of character strings and compression codes have been registered, based on the password input from the input unit 5. In the above-described first and second embodiments, in the case that the value of the generated remainder S is 1, it may be assumed that changes to the combination of character codes and compression codes only occur in adjacent combinations. However, according to the present embodiment, a seed having a sufficient predetermined length is obtained from the password as the length of the seed used for the second hash function, and the hash value is generated from the seed using the second hash value. Therefore, the hash value generated by the second hash function may be uneven. Accordingly, according to the present embodiment, the probability of changes to the combinations of character codes and compression codes occurring only in adjacent combinations is lower than in the first and second embodiments.

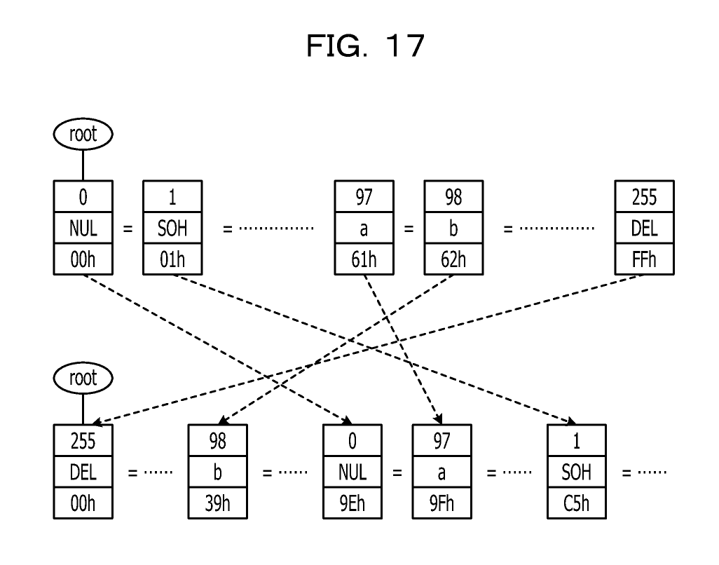

FIG. 17 is a diagram to describe an example of change of compression codes according to the third embodiment. In the example in FIG. 17, the changing unit 33b changes the compression code of the characters “NUL” from “00” to “9E”. Also, in the example in FIG. 17, the changing unit 33b changes the compression code of the characters “SOH” from “01” to “C5”. Also, in the example in FIG. 17, the changing unit 33b changes the compression code of the character “a” from “61” to “9F”. Also, in the example in FIG. 17, the changing unit 33b changes the compression code of the character “b” from “62” to “39”. Also, in the example in FIG. 17, the changing unit 33b changes the compression code of the characters “DEL” from “FF” to “00”.

Thus, with the server 31 according to the present embodiment, the compression codes of the first generation leaves and nodes of the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed. Therefore, decoding a character string that includes the multiple types of characters in the leading character is also difficult.

Also, with the server 31 according to the present embodiment, compression data that is difficult to decipher is generated just by scrambling the compression codes of the dictionary 8b, without performing complicated encryption processing. Accordingly, with the server 31 according to the present embodiment, obfuscating is enabled by simple compression processing. Also, the processing cost increase corresponding to the size increase of the data to be processed can be suppressed.

Also, with the server 31 according to the present embodiment, just by scrambling the compression codes of the dictionary 8b, obfuscating of compression data is readily enabled since scrambling processing is not performed on the compressed data and raw data each time the data is compressed.

The user terminal 32 has an input unit 10, output unit 11, transmission/reception unit 12, storage unit 13, and control unit 34.

The control unit 34 has an internal memory to store various types of programs stipulating processing procedures and control data, thereby executing various types of processing. As illustrated in FIG. 15, the control unit 24 has a decompression unit 34a, changing unit 34b, and playing unit 14c.

The decompression unit 34a performs processing similar to the decompression unit 14a according to the first embodiment. That is to say, the decompression unit 34a uses the dictionary 13b wherein a combination of character codes and compression codes has been modified with the later-described changing unit 34b, and compresses digital content file data. Also, the decompression unit 34a newly registers, in the dictionary 13b, combinations of character strings that include decompressed characters and that are unregistered in the dictionary 13b, and compression codes.

The changing unit 34b changes the combinations of character strings and compression codes in the dictionary 13b in which multiple combinations of character strings and compression codes are registered based on the password input from the input unit 10. Description will be given with a specific example. First, the changing unit 34b obtains a password. The changing unit 34b then uses a first hash function such as SHA-256 or the like, using the password as a seed, and obtains a hash value of a predetermined length to be used for the next second hash function. Next, the change unit 34b further uses a second hash function, and obtains a hash value from the seed. Thus, generating a seed from the password using the first hash function is to obtain a seed of a sufficiently long predetermined length to be used for the second hash function.

Subsequently, the changing unit 34b correlates the value of “00” in hexadecimal as the compression code before changing, and the hash value as the compression code after changing, and stores this in the storage unit 13. Next, the changing unit 34b uses the second hash function again to obtain a hash value from the seed. The changing unit 34b then determines whether or not the obtained hash value is registered in the storage unit 13 as a compression code after the obtained hash value is changed. In the case that the obtained hash value is stored in the storage unit 13 as the compression code after changing, the changing unit 34b performs processing such as the following. That is to say, the changing unit 34b repeatedly performs incrementing the obtained hash value by 1 and determining whether or not the hash value is stored in the storage unit 13 as the compression code after changing, until a negative determination is made. In the case that the hash value is not stored in the storage unit 13 as the compression code after changing, the changing unit 34b correlates the value of “01” in hexadecimal as the compression code before changing and the hash value of the compression code after changing, and stores this in the storage unit 13.

The changing unit 34b repeatedly performs such processing for the multiple character compression codes that have been registered in the dictionary 13b at time of initialization. For example, in the case that compression codes for 256 types of characters from “00” to “FF” in hexadecimal are registered in the dictionary 13b at time of initialization, the changing unit 34b handles the 256 compression codes from “00” to “FF” as the compression codes before changing. Also, the changing unit 34b generates compression codes after changing, as to each of the compression codes before changing, correlates the compression codes before changing and the compression codes after changing, and stores these in the storage unit 13.

The changing unit 34b changes each of the compression codes registered in the dictionary 13b at time of initialization into the corresponding compression codes after changing.

Therefore, with the user terminal 32 according to the present embodiment, in the case that the input password does not match the correct password input by the server 31, as long as the hash values obtained from both passwords do not match, the decompressed data will not be correct. Accordingly, with the user terminal 32 according to the present embodiment, obfuscation can be readily enabled.

The control unit 34 has an integrated circuit such as ASIC (Application Specific Integrated Circuit) or FPGA (Field Programmable Gate Array). Note that the control unit 34 may have an electronic circuit such as a CPU (Central Processing Unit) or MPU (Micro Processing Unit).

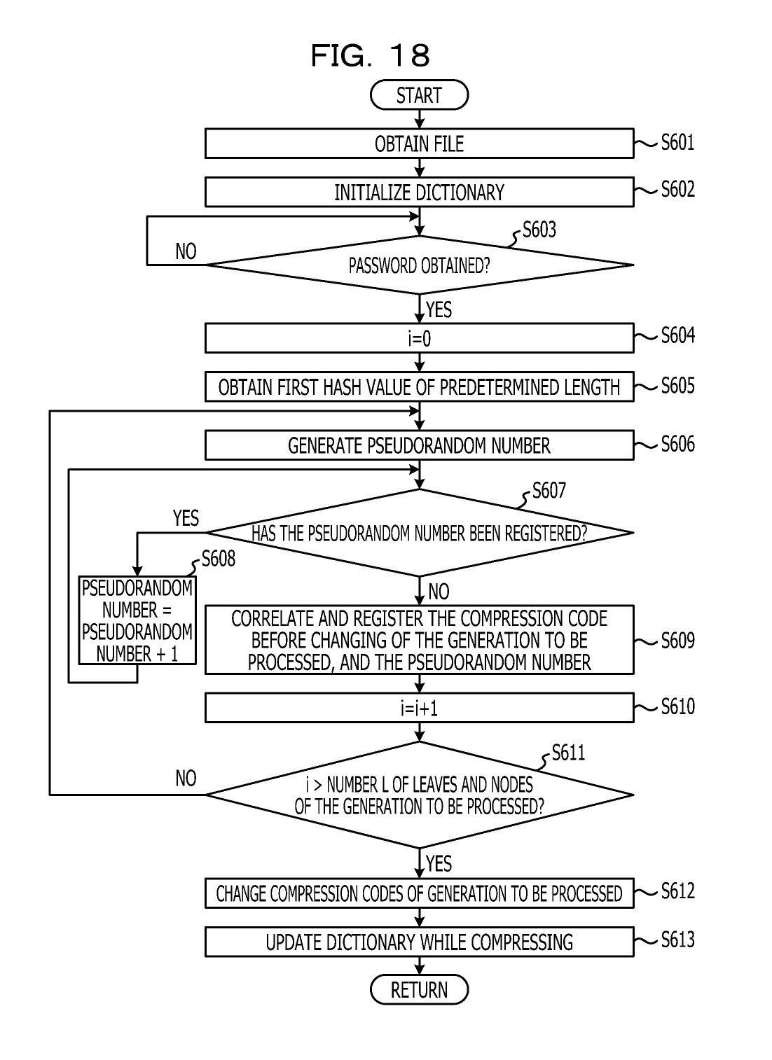

Next, a processing flow of the server 31 according to the present embodiment will be described. FIG. 18 is a flowchart illustrating the procedures of the compression processing according to the third embodiment. Various timings may be considered for the execution timing of the compression processing. For example, the compression processing may be executed in the case that the digital content is input from the input unit 5. Note that the processing flow of the system 30 according to the present embodiment is similar to the processing flow illustrated in the sequence diagram of the system 1 according to the first embodiment, so the description will be omitted.

The steps S601 through S603 illustrated in FIG. 18 are similar to the steps S201 through S203 illustrated in FIG. 8 above, so the description thereof will be omitted. As illustrated in FIG. 18, the changing unit 33b sets “0” as the value of a variable i (S604). The changing unit 33b uses the first hash function, using the password as a seed, and obtains as a seed a hash value of a predetermined length to be used for the next second hash function (S605). The changing unit 33b uses a function for generating a pseudorandom number and causes a pseudorandom to be generated from the seed (S606). The changing unit 33b determines whether or not the pseudorandom number is registered in the storage unit 8 as a “compression code after changing” (S607). In the case the pseudorandom is registered (Yes in S607), the changing unit 33b increments the value of the pseudorandom number by 1 (S608), and the flow returns to S607.

On the other hand, in the case the pseudorandom is not registered (No in S607), the changing unit 33b correlates the variable i serving as the “compression code before changing” of the generation to be processed and the pseudorandom number serving as the “compression code after changing”, and registers this in the storage unit 8 (S609). Note that according to the present embodiment, the generation to be processed is the first generation. The changing unit 33b increments the value of the variable i by 1 (S610). The changing unit 33b determines whether or not the value of the variable i is greater than the number L of leaves and nodes of the generation to be processed (S611). In the case that the value of the variable i is the number L or less (No in S611), the flow returns to S606. On the other hand, in the case that the value of the variable i is greater than the number L (Yes in S611), the changing unit 33b changes each of the compression codes registered in the dictionary 8b at time of initialization into the corresponding compression codes after changing (S612). The compression unit 33a uses the dictionary 8b and compresses the digital content file data, while updating the dictionary 8b (S613), stores the processing result in the internal memory of the control unit 33, and returns.

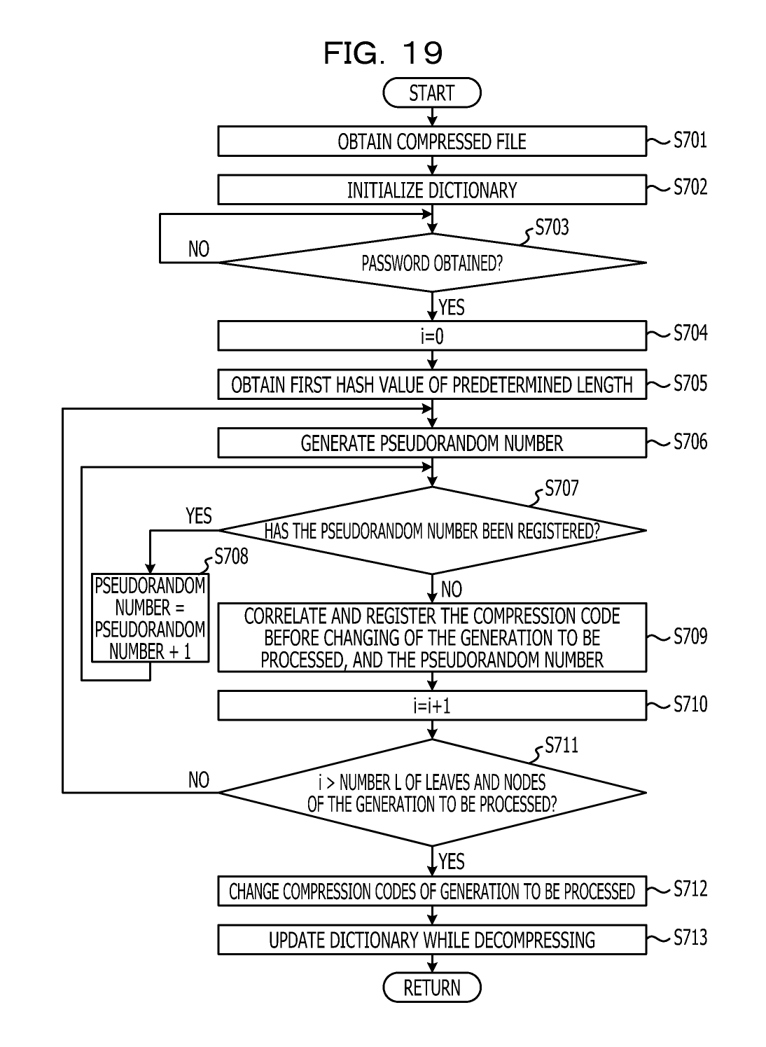

Next, a processing flow of the user terminal 32 according to the present embodiment will be described. FIG. 19 is a flowchart illustrating procedures of the decompression processing according to the third embodiment. With the decompression processing also, the dictionary updating algorithm that is common to the compression processing described in FIG. 18 is used. The steps S701 through S703 in FIG. 19 are similar to the steps S301 through S303 in FIG. 9, so the description thereof will be omitted. As illustrated in FIG. 19, the changing unit 34b sets “0” as the value of a variable i (S704). The changing unit 34b uses the first hash function, using the password as a seed, and obtains as a seed a hash value of a predetermined length to be used for the next second hash function (S705). The changing unit 34b uses a function for generating a pseudorandom number and causes a pseudorandom to be generated from the seed (S706). The changing unit 34b determines whether or not the pseudorandom number is registered in the storage unit 8 as a “compression code after changing” (S707). In the case the pseudorandom is registered (Yes in S707), the changing unit 34b increments the value of the pseudorandom number by 1 (S708), and the flow returns to S707.

On the other hand, in the case the pseudorandom is not registered (No in S707), the changing unit 34b correlates the variable i serving as the “compression code before changing” of the generation to be processed and the pseudorandom number serving as the “compression code after changing”, and registers this in the storage unit 8 (S709). Note that according to the present embodiment, the generation to be processed is the first generation. The changing unit 34b increments the value of the variable i by 1 (S710). The changing unit 34b determines whether or not the value of the variable i is greater than the number L of leaves and nodes of the generation to be processed (S711). In the case that the value of the variable i is the number L or less (No in S711), the flow returns to S706. On the other hand, in the case that the value of the variable i is greater than the number L (Yes in S711), the changing unit 34b changes each of the compression codes registered in the dictionary 8b at time of initialization into the corresponding compression codes after changing (S712). The decompression unit 34a uses the dictionary 8b and decompresses the digital content file data, while updating the dictionary 8b (S713), stores the processing result in the internal memory of the control unit 34, and returns.

As described above, with the server 31 according to the present embodiment, the compression codes of the leaves and nodes of the first generation in the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed. Therefore, deciphering a character string that includes the multiple types of characters in the leading character is also difficult.

Also, with the server 31 according to the present embodiment, compression data that is difficult to decipher is generated just by scrambling the compression codes of the dictionary 8b, without performing complicated encryption processing. Accordingly, with the server 31 according to the present embodiment, obfuscating is enabled by simple compression processing. Also, the processing cost increase corresponding to the size increase of the data to be processed can be suppressed.

Also, with the server 31 according to the present embodiment, just by scrambling the compression codes of the dictionary 8b, obfuscating of compression data is readily enabled since scrambling processing is not performed on the compressed data and raw data each time the data is compressed.

Therefore, with the user terminal 32 according to the present embodiment, in the case that the input password does not match the correct password input by the server 31, as long as the hash values obtained from both passwords do not match, the decompressed data will not be correct. Accordingly, with the user terminal 32 according to the present embodiment, obfuscation can be readily enabled.

Next, a fourth embodiment will be described.

In the third embodiment described above, a case of changing the combinations of first generation character codes and compression codes using another method different from those in the first and second embodiments is exemplified, but the apparatus disclosed is not limited to this. Thus, in the fourth embodiment, a case of changing the combinations of characters and compression codes for the second generation and thereafter, using a similar method as the method in the third embodiment, will be described.

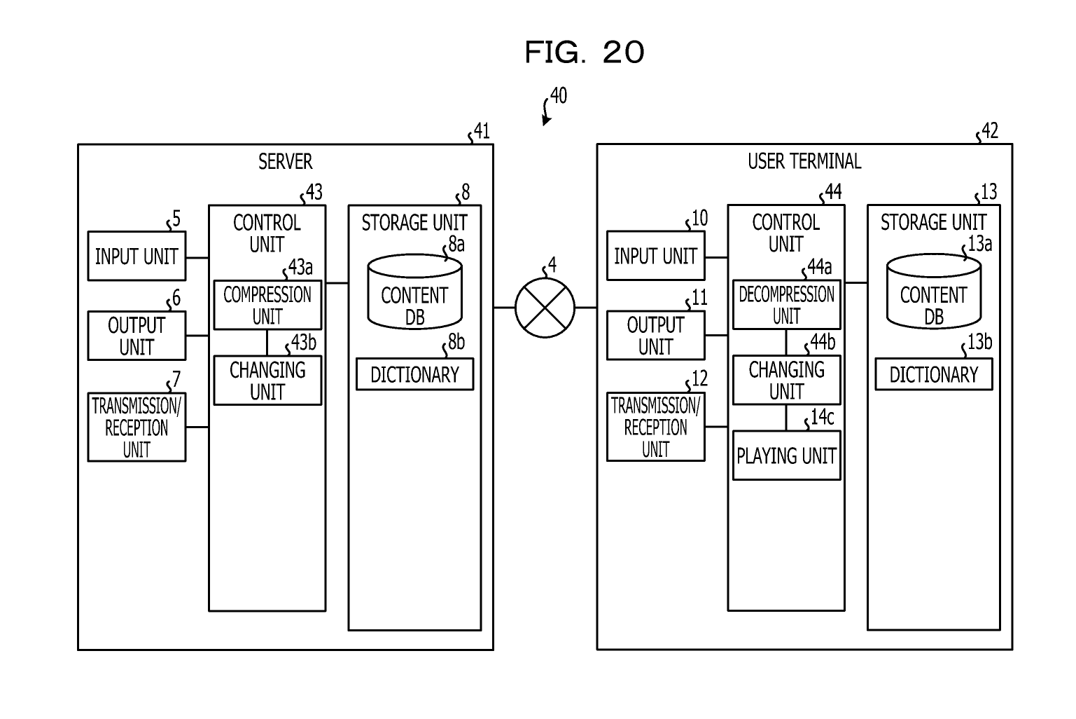

A system according to the fourth embodiment will be described. FIG. 20 is a diagram illustrating an example of a system configuration according to the fourth embodiment. A system 40 according to the present embodiment has a server 41 and user terminal 42. The server 41 differs from the first embodiment in having a control unit 43 instead of the control unit 9 according to the first embodiment. The user terminal 42 differs from the first embodiment in having a control unit 44 instead of the control unit 14 according to the first embodiment. Now, in the description below, there are cases where the same reference numerals are appended as in FIGS. 1, 10, and 15 for parts and devices that perform similar functions to the first through third embodiments, and descriptions thereof are omitted. The server 41 compresses digital content file data such as a dictionary or electronic book. The server 41 transmits the compressed digital content file data to the user terminal 42 via the Internet 4. The user terminal 42 decompresses the received digital content file data. The user terminal 42 plays the decompressed digital content file.

The server 41 has an input unit 5, output unit 6, transmission/reception unit 7, storage unit 8, and control unit 43.

The control unit 43 has an internal memory to store various types of programs stipulating processing procedures and control data, thereby executing various types of processing. As illustrated in FIG. 20, the control unit 43 has a compression unit 43a and changing unit 43b.

The compression unit 43a performs processing similar to the compression unit 9a according to the first embodiment. That is to say, the compression unit 43a uses the dictionary 8b wherein a combination of character codes and compression codes has been modified with the later-described changing unit 43b, and compresses digital content file data. Also, the compression unit 43a newly registers, in the dictionary 8b, combinations of character strings that include compressed characters before the characters had been compressed and that are unregistered in the dictionary 8b, and compression codes.

The changing unit 43b performs similar processing as the changing unit 33b according to the third embodiment. Further, the changing unit 43b newly changes the combinations of the character strings and compression codes newly registered in the dictionary 8b, based on the password input by the input unit 5. Description will be given with a specific example.

Of the characters in the newly registered character string, the changing unit 43b identifies the generation of the newly added characters as the generation to be processed, each time a combination of character strings and compression codes is newly registered in the dictionary 8b.

The changing unit 43b changes the combinations of the character strings and compression codes of the identified generation to be processed with a method similar to the method used for changing the combinations of the first generation character strings and compression codes registered in the dictionary 8b by the changing unit 33b according to the third embodiment. That is to say, the changing unit 43b sets each of the compression codes of the identified generation to be processed as a “compression code before changing”, and uses the second hash function for each “compression code before changing” to generate a hash value from a seed. Now, the changing unit 43b adjusts the range of the hash values so that the generated hash value will be a value according to the identified generation, e.g., in the case that the identified generation is the second generation, the generated hash value will be “100” or greater in hexadecimal. The changing unit 43b correlates each of the “compression codes before changing” and each of the hash values, and registers these in the storage unit 8. FIG. 21 is a diagram to describe an example of processing executed by the system relating to the fourth embodiment. The example in FIG. 21 illustrates an example of the processing of the change unit 43b in the case that the combination of the codes and compression codes of the character string “about” which has not been registered in the dictionary 8b is newly registered in the dictionary 8b by the compression unit 43a. In the example in FIG. 21, the changing unit 43b changes the compression code of the second generation character “b” in the character string “about” from “100” to “161”. Also, in the example in FIG. 21, the changing unit 43b changes the compression code of the third generation character “o” from “101” to “1FF”. Also, in the example in FIG. 21, the changing unit 43b changes the compression code of the fourth generation character “u” from “102” to “100”. Also, in the example in FIG. 21, the changing unit 43b changes the compression code of the fifth generation character “t” from “103” to “1B2”.

Thus, with the server 41 according to the present embodiment, the compression codes of the leaves and nodes of the first generation in the dictionary 8b and the generation newly added to the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed.

Also, with the server 41 according to the present embodiment, compression data that is difficult to decipher is generated just by scrambling the compression codes of the dictionary 8b, without performing complicated encryption processing. Accordingly, with the server 41 according to the present embodiment, obfuscating is enabled by simple compression processing. Also, the processing cost increase corresponding to the size increase of the data to be processed can be suppressed.

Also, with the server 41 according to the present embodiment, just by scrambling the compression codes of the dictionary 8b, obfuscating of compression data is readily enabled since scrambling processing is not performed on the compressed data and raw data each time the data is compressed.

The user terminal 42 has an input unit 10, output unit 11, transmission/reception unit 12, storage unit 13, and control unit 44.

The control unit 44 has an internal memory to store various types of programs stipulating processing procedures and control data, thereby executing various types of processing. As illustrated in FIG. 20, the control unit 44 has a decompression unit 44a, changing unit 44b, and playing unit 14c.

The decompression unit 44a performs processing similar to the decompression unit 14a according to the first embodiment. That is to say, the decompression unit 44a uses the dictionary 13b wherein a combination of character codes and compression codes has been modified with the later-described changing unit 44b, and compresses digital content file data. Also, the decompression unit 44a newly registers, in the dictionary 13b, combinations of character strings that include decompressed characters and that are unregistered in the dictionary 13b, and compression codes.

The changing unit 44b performs processing similar to the changing unit 34b according to the third embodiment. Further, the changing unit 44b newly changes the combinations of character strings and compression codes newly registered in the dictionary 13b, based on the password input from the input unit 10. Description will be given with a specific example.

The changing unit 44b identifies the generation of the newly added characters, of the characters in the newly registered character string, as the generation to be processed, each time a combination of character strings and compression codes is newly registered in the dictionary 13b.

The changing unit 44b changes the combinations of the character strings and compression codes of the identified generation to be processed with a method similar to the method used for changing the combinations of the first generation character strings and compression codes registered in the dictionary 13b by the changing unit 34b according to the third embodiment. That is to say, the changing unit 44b sets each of the compression codes of the identified generation to be processed as “compression code before changing” and uses the second hash function for each “compression code before changing” to generate a hash value from a seed. Now, the changing unit 44b adjusts the range of the hash values so that the generated hash value will be a value according to the identified generation, e.g., in the case that the identified generation is the second generation, the generated hash value will be “100” or greater in hexadecimal. The changing unit 44b correlates each of the “compression codes before changing” and each of the hash values, and registers these in the storage unit 8.

Therefore, with the user terminal 42 according to the present embodiment, in the case that the input password does not match the correct password input by the server 41, as long as the hash values obtained from both passwords do not match, the decompressed data will not be correct. Accordingly, with the user terminal 42 according to the present embodiment, obfuscation can be readily enabled.

The control unit 44 has an integrated circuit such as ASIC (Application Specific Integrated Circuit) or FPGA (Field Programmable Gate Array). Note that the control unit 44 may have an electronic circuit such as a CPU (Central Processing Unit) or MPU (Micro Processing Unit).

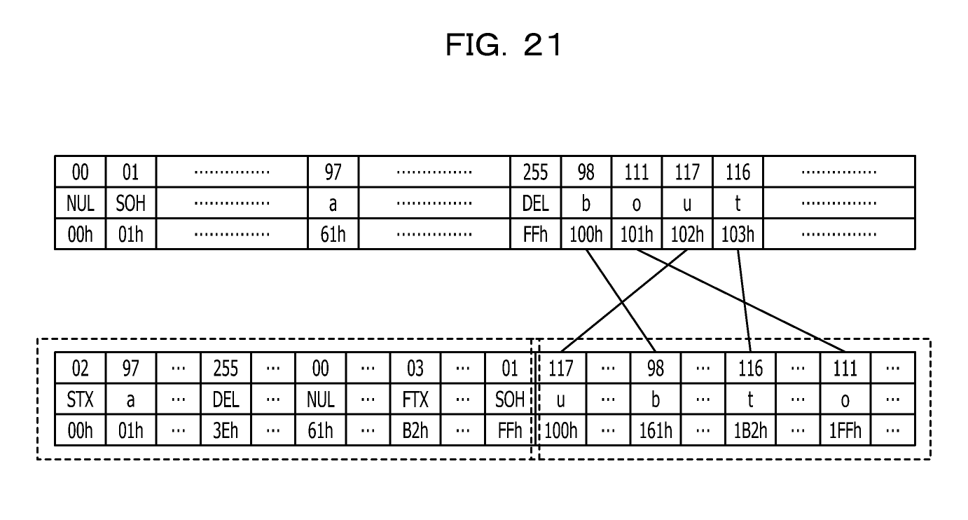

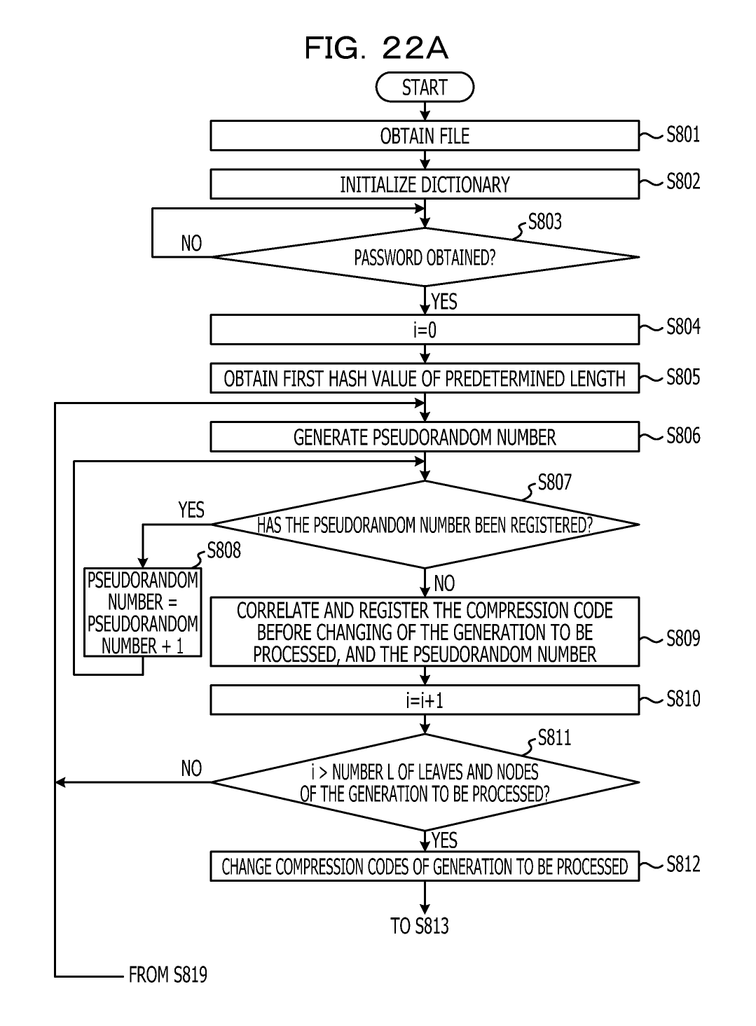

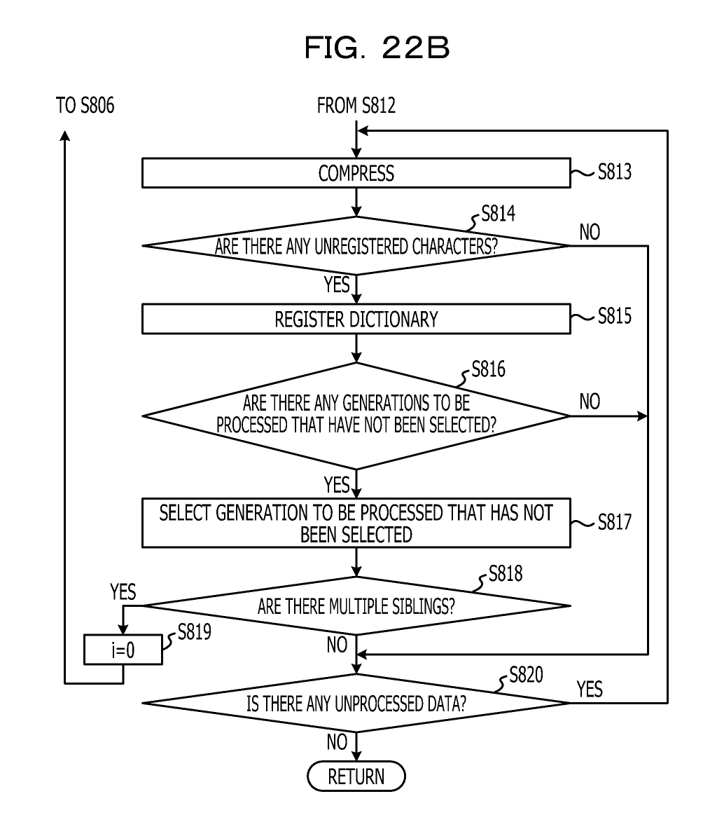

Next, a processing flow of the server 41 according to the present embodiment will be described. FIG. 22 is a flowchart illustrating the procedures of the compression processing according to the fourth embodiment. Various timings may be considered for the execution timing of the compression processing. For example, the compression processing may be executed in the case that the digital content is input from the input unit 5. Note that the processing flow of the system 40 according to the present embodiment is similar to the processing flow illustrated in the sequence diagram of the system 1 according to the first embodiment, so the description will be omitted.

The steps S801 through S812 described in FIG. 22 are similar to the steps S601 through S612 described in FIG. 18, so the description thereof will be omitted. As illustrated in FIG. 22, the compression unit 43a uses the dictionary 8b and compresses digital content file data (S813). The compression unit 43a determines whether or not, of the character strings indicated by the digital content file data, the codes of the character string that include the character string of the portion compressed this time in the lead portion are unregistered in the dictionary 8b (S814). In the case the codes are unregistered (Yes in S814), the compression unit 43a newly registers combinations of character strings that include compressed character strings before the character strings had been compressed and that are unregistered in the dictionary 8b, and compression codes, in the dictionary 8b (S815).

On the other hand, in the case that the codes are not unregistered (No in S814), the compression unit 43a determines, of the digital content file data, whether there is any data that has not been subjected to compression processing (S820). In the case there is data that has not been subjected to compression processing (Yes in S820), the flow is returned to S813. In the case there is no data that has not been subjected to compression processing (No in S820), the compression unit 43a stores the processing result in the internal memory of the control unit 43, and returns.

The changing unit 43b identifies the generation of the newly added characters, of the characters in the character string newly registered in the dictionary 8b, as the generation to be processed, and determines whether, of the identified generations to be processed, there are any generations to be processed that are not selected in the S817 below (S816). In the case there are generations to be processed that have not been selected (Yes in S816), the changing unit 43b selects one of the generations to be processed that has not been selected (S817). The changing unit 43b determines whether or not there are multiple numbers of leaves and nodes of the selected generation to be processed (S818). In the case there are multiple numbers (Yes in S818), the changing unit 43b sets the value of a variable i to 0 (S819). The changing unit 43b causes a pseudorandom to be generated again (S806), and determines whether the pseudorandom number is registered in the storage unit 8 as a “compression code after changing” (S807). In the case the pseudorandom is not registered in the storage unit 8 (No in S807), the changing unit 43b correlates the “compression codes before changing” of the generation to be processed and the pseudorandom numbers serving as “compression codes after changing”, and registers these in the storage unit 8 (S809).

On the other hand, in the case there are no generations to be processed that have not been selected (No in S816), or in the case there are not multiple numbers (No in S818), the flow is advanced to S820.

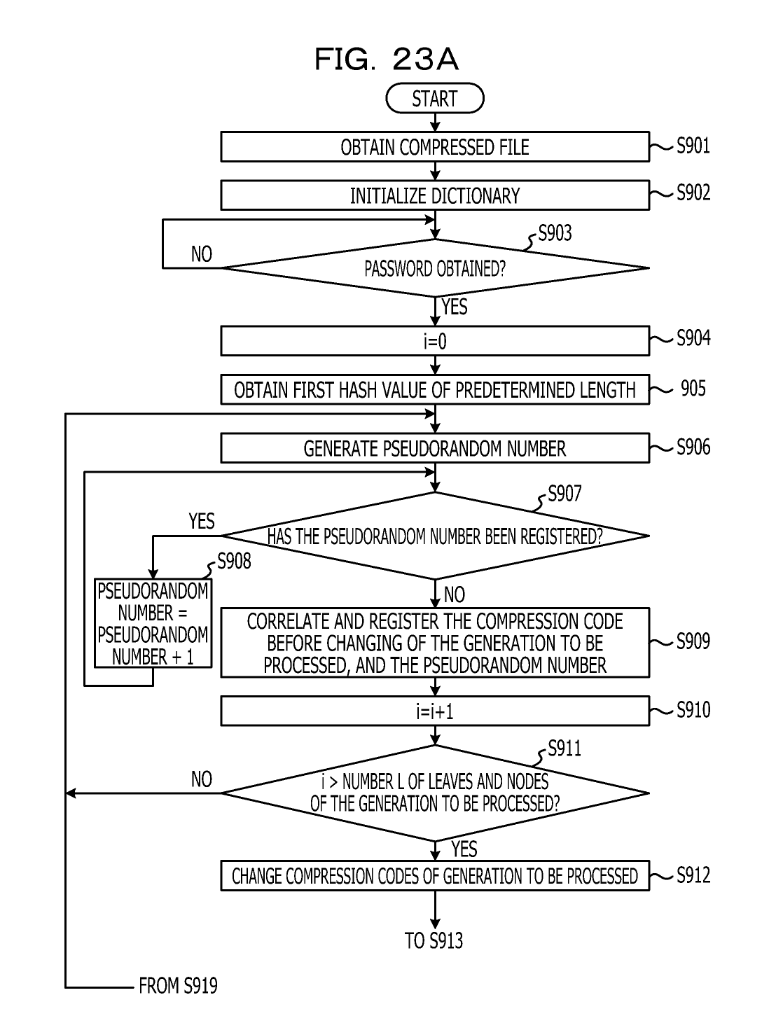

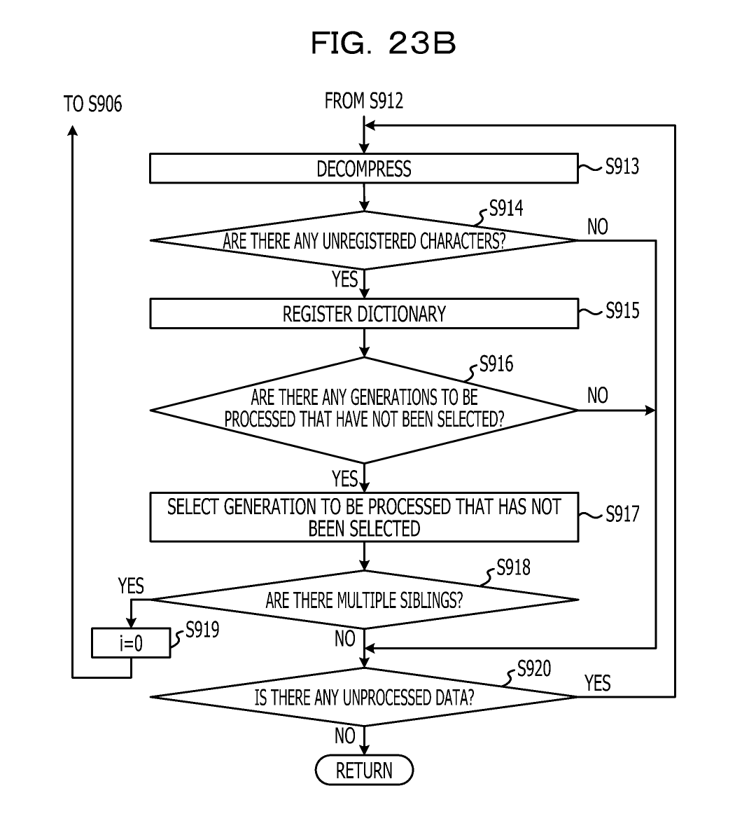

Next, a processing flow of the user terminal 42 according to the present embodiment will be described. FIG. 23 is a flowchart illustrating procedures of the decompression processing according to the fourth embodiment. The steps S901 through S912 in FIG. 23 are similar to the steps S701 through S712 in FIG. 19, so the description thereof will be omitted. As illustrated in FIG. 23, the decompression unit 44a uses the dictionary 13b and decompresses digital content file data (S913). The decompression unit 44a determines whether or not, of the character strings indicated by the data of the file of the digital content, the codes of the character string that include the character string of the portion decompressed this time in the lead portion are unregistered in the dictionary 13b (S914). In the case there are unregistered codes (Yes in S914), the decompression unit 44a newly registers, in the dictionary 13b, a combination of the character string codes that are character strings including the character strings before the compressed character strings are compressed, and that are unregistered in the dictionary 13b, and the compression codes (S915).

On the other hand, in the case the codes are not unregistered (No in S914), the decompression unit 44a determines whether or not there is any data, of the digital content file data, not subjected to compression processing (S920). In the case there is data not subjected to compression processing (Yes in S920), the flow is returned to S913. In the case there is no data not subjected to compression processing (No in S920), the decompression unit 44a stores the processing result in the internal memory of the control unit 44, and returns.

The changing unit 44b identifies the generation of the newly added characters, of the characters in the newly registered character string in the dictionary 13b, as the generation to be processed, and determines whether, of the identified generations to be processed, there are any generations to be processed that are not selected in the S917 below (S916). In the case there are generations to be processed that have not been selected (Yes in S916), the changing unit 44b selects one of the generations to be processed that has not been selected (S917). The changing unit 44b determines whether or not there are multiple numbers of leaves and nodes of the selected generation to be processed (S918). In the case there are multiple numbers (Yes in S918), the changing unit 44b sets the value of a variable i to 0 (S919). The changing unit 44b causes a pseudorandom to be generated again (S906), and determines whether the pseudorandom number is registered in the storage unit 13 as a “compression code after changing” (S907). In the case the pseudorandom is not registered in the storage unit 13 (No in S907), the changing unit 44b correlates the “compression codes before changing” of the generation to be processed and the pseudorandom numbers serving as “compression codes after changing”, and registers these in the storage unit 13 (S909).

On the other hand, in the case there are no generations to be processed that have not been selected (No in S916), or in the case there are not multiple numbers (No in S918), the flow is advanced to S920.

As described above, with the server 41 according to the present embodiment, the compression codes of the first generation in the dictionary 8b and the generation of the newly added characters of the character string newly registered in the dictionary 8b are scrambled, and the combinations of codes and compression codes are changed. Thus, an attacker who attempts to decipher the compressed data, even if understanding the multiple types of combinations of the character codes and compression codes registered in the dictionary 8b at time of initialization, can have difficulty in deciphering the multiple types of characters, since the combinations are changed.

Also, with the server 41 according to the present embodiment, compression data that is difficult to decipher is generated just by scrambling the compression codes of the dictionary 8b, without performing complicated encryption processing. Accordingly, with the server 41 according to the present embodiment, obfuscating is enabled by simple compression processing.

Also, with the server 41 according to the present embodiment, just by scrambling the compression codes of the dictionary 8b, obfuscating of compression data is readily enabled since scrambling processing is not performed on the compressed data and raw data each time the data is compressed. Also, the processing cost increase corresponding to the size increase of the data to be processed can be suppressed.

Also, with the user terminal 42 according to the present embodiment, in the case that the input password does not match the correct password input by the server 41, in the case that the input password does not match the correct password input by the server 41, as long as the hash values obtained from both passwords do not match, the decompressed data will not be correct. Accordingly, with the user terminal 42 according to the present embodiment, obfuscation can be readily enabled.

Next, a fifth embodiment will be described.

Now, in the first through fourth embodiment described above, cases of using the LZ 78 compression method as the compression method to compress data has been exemplified, but the apparatus disclosed is not limited to this. Thus, in the fifth embodiment, a case of using a LZ 77 compression method as the compression method to compress data will be described.

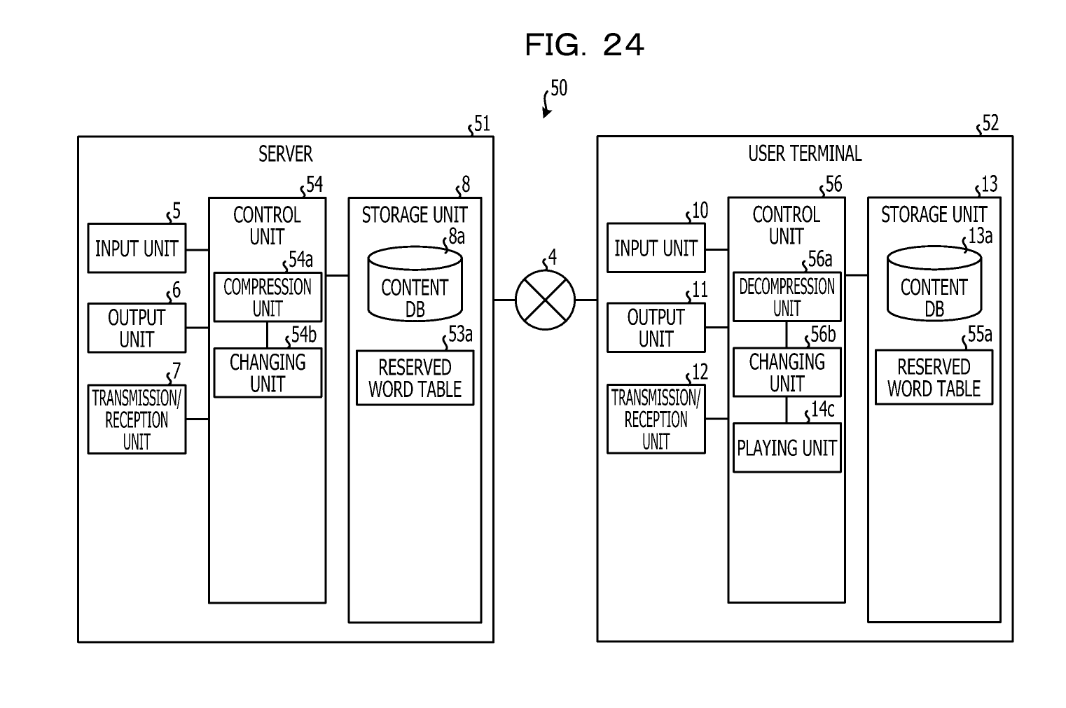

A system according to the fifth embodiment will be described. FIG. 24 is a diagram illustrating an example of a system configuration according to the fifth embodiment. A system 50 according to the present embodiment has a server 51 and user terminal 52. The server 51 differs from the first embodiment in having a storage unit 53 and control unit 54 instead of the storage unit 8 and control unit 9 according to the first embodiment. The user terminal 52 differs from the first embodiment in having a storage unit 55 and control unit 56 instead of the storage unit 13 and control unit 14 according to the first embodiment. Now, in the description below, there are cases where the same reference numerals are appended as in FIGS. 1, 10, 15, and 20 for parts and devices that perform similar functions to the first through fourth embodiments, and descriptions thereof are omitted. The server 51 compresses digital content file data such as a dictionary or electronic book. The server 51 transmits the compressed digital content file data to the user terminal 52 via the Internet 4. The user terminal 52 decompresses the received digital content file data. The user terminal 52 plays the decompressed digital content file.

The server 51 has an input unit 5, output unit 6, transmission/reception unit 7, storage unit 53, and control unit 54.

The storage unit 53 stores various types of information. For example, the storage unit 53 stores a content DB 8a and a reserved word table 53a.

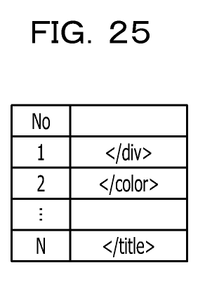

HTML (Hyper Text Markup Language) tags that are included in the digital content data and that have a higher appearance frequency than general characters, and characters having a higher appearance frequency, are registered in the reserved word table 53a. The reserved word table 53a is used in the event of compressing a digital content file with the later-described compression unit 54b. FIG. 25 is a diagram illustrating an example of a reserved word table. The example in FIG. 25 illustrates a case where N tags are registered in the reserved table 53a. The example in FIG. 25 illustrate a case where an HTML “</div>” tag is registered in the first record of the reserved word table 53a. Also, the example in FIG. 25 illustrate a case where an HTML “</color>” tag is registered in the second record of the reserved word table 53a. The example in FIG. 25 illustrate a case where an HTML “</title>” tag is registered in the N'th record of the reserved word table 53a.

The storage unit 53 is a semiconductor memory device such as flash memory or a storage apparatus such as a hard disk, optical disk, or the like. Note that the storage unit 53 is not limited to the above-mentioned types of storage apparatuses, and may be RAM (Random Access Memory) or ROM (Read Only Memory).

The control unit 54 has an internal memory to store various types of programs stipulating processing procedures and control data, thereby executing various types of processing. As illustrated in FIG. 24, the control unit 54 has a generating unit 54a and compression unit 54b.

The generating unit 54a generates a character string in accordance with the password input from the input unit 5. For example, the generating unit 54a calculates the sum of the digits in the password. The generating unit 54a calculates the remainder D in the case of dividing the computed sum by the number N of tags registered in the reserved word table 53a. Next, using the record of the number indicated by the value of the remainder D as a starting point, the generating unit 54a obtains the tags registered in the records in the reserved word table 53a, and generates a character string by joining the obtained tags. Thus, the generating unit 54a generates a character string that arrays reserved words of which the order of registration in the reserved word table 53a has been changed.

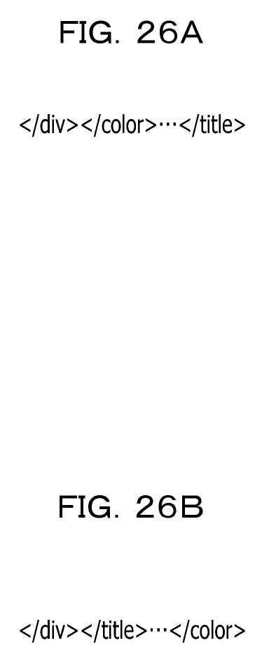

FIGS. 26A and 26B are diagrams illustrating an example of a character string generated by the generating unit. The example in FIG. 26A illustrates an example of a case where the generating unit 54a generates a character string using the first record as a starting point, in the case that the remainder D having a value of “1” is calculated by the generating unit 54a in the example in FIG. 25. That is to say, the example in FIG. 26A illustrates a case where the generating unit 54a obtains the tags registered in the records of the first, second, third, . . . , and N'th records of the reserved word table 53a, and generates a character string “</div></color> . . . </title>” by joining the obtained tags. Also, the example in FIG. 26B illustrates an example of a case where the generating unit 54a generates a character string using the first record as a starting point, in the case that the remainder D having a value of “1” is calculated by the generating unit 54a. That is to say, the example in FIG. 26B illustrate a case where the generating unit 54a obtains the tags registered in the records of the first, N'th, (N−1)'th, . . . , and second records of the reserved word table 53a, and generates a character string “</div></title> . . . </color>” by joining the obtained tags.

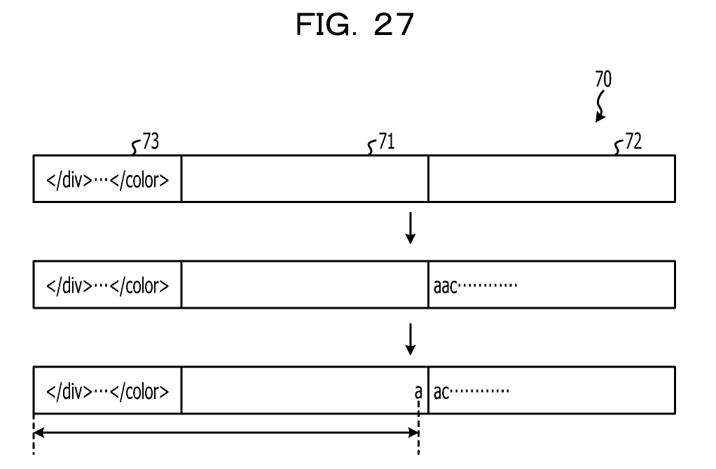

The compression unit 54b uses the character string generated by the generating unit 54a and the character string before the compressed character string is compressed, and compresses the character string. Description will be given with a specific example. FIG. 27 is a diagram to describe the system processing according to the fifth embodiment. In the example in FIG. 27, a setting unit 73 to set the character string in the event of initialization is further provided to the lead of a sliding window 70 having a reference unit 71 and encoding unit 72. The compression unit 54b sets the character string generated by the generating unit 54a in the setting unit 73. Now, even if the sliding window 70 slides over the data, the character string set in the setting unit 73 remains set. The example in FIG. 27 illustrates a case of the character string “</div> . . . </color>” set in the setting unit 73.

In the case of compressing the lead data within the encoding unit 72, the compression unit 54b generates a pointer indicating the position of the longest coincident series within the setting unit 73 and reference unit 71, and the length of the longest coincident series. Now, the compression unit 54b searches for the longest data that matches the lead data within the encoding unit 72, from the setting unit 73 and reference unit 71. Also, compression unit 54b uses the address from the lead of the character string set in the setting unit 73 as the position of the longest coincident series included in the pointer, not the address from the lead of the reference unit 71.

Thus, according to the server 51 according to the present embodiment, characters and tags having a high appearance frequency are set in the setting unit 73 at the time of initialization, so the compression efficiency is good. Also, in the server 51 according to the present embodiment, the position of the longest coincident series indicated by the pointer is the address from the lead of the character string set in the setting unit 73. Therefore, according to the server 51 relating to the present embodiment, in the case that an attacker who attempts to decipher the compressed data understands the position of the longest coincident series indicated by the pointer to be the address from the lead of the reference unit 71, the difficulty in deciphering the compressed data by an attacker can be increased.

Also, with the server 51 according to the present embodiment, compression codes can be scrambled with simple processing as compared to encryption processing such as RSA, where a character string is set in the setting unit 73 and the position of the longest coincident series indicated by the pointer is the address from the lead of the character string set in the setting unit 73. Thus, the server 51 according to the present embodiment generates compression data of which deciphering is difficult without performing complicated encryption processing. Accordingly, with the server 51 according to the present embodiment, obfuscating is enabled by simple compression processing. Also, the processing cost increase corresponding to the size increase of the data to be processed can be suppressed.

Also, with the server 51 according to the present embodiment, the position of the longest coincident series indicated by the pointer is set as the address from the lead of the character string set in the setting unit 73, and scrambling processing is not performed for the compressed data and raw data each time the data is compressed. Therefore, with the server 51 according to the present embodiment, obfuscating of data is enabled by simple compression processing.

The user terminal 52 has an input unit 10, output unit 11, transmission/reception unit 12, storage unit 55, and control unit 56.

The storage unit 55 stores various types of information. For example, the storage unit 55 stores a content DB 8a and a reserved word table 55a.

The reserved word table 55a is a table similar to the above-described reserved word table 53a so the description thereof will be omitted.

The storage unit 55 is a semiconductor memory device such as flash memory or a storage apparatus such as a hard disk, optical disk, or the like. Note that the storage unit 55 is not limited to the above-mentioned types of storage apparatuses, and may be RAM (Random Access Memory) or ROM (Read Only Memory).

The control unit 56 has an internal memory to store various types of programs stipulating processing procedures and control data, thereby executing various types of processing. As illustrated in FIG. 24, the control unit 56 has a generating unit 56a, decompression unit 56b, and playing unit 14c.

The generating unit 56a performs processing similar to the generating 54a described above. That is to say, the generating unit 56a generates a character string in accordance with the password input from the input unit 10. For example, the generating unit 56a calculates the sum of the digits in the password. The generating unit 56a calculates the remainder D in the case of dividing the calculated sum by the number N of tags registered in the reserved word table 55a. Next, using the record of the number indicated by the value of the remainder D as a starting point, the generating unit 56a obtains the tags registered in the records in the reserved word table 55a, and generates a character string by joining the obtained tags.

The decompression unit 56b uses the character string generated by the generating unit 56a and the decompression character string to decompress the compressed character string. Description will be given with a specific example. The decompression unit 56b sets the character string generated by the generating unit 56a in the setting unit 73. Now, even if the sliding window 70 slides over the data, the character string set in the setting unit 73 remain set.

In the case of decompressing the pointer within the encoding unit 72, the decompression unit 56b identifies the characters indicated by the address from the lead of the character string set in the setting unit 73 indicated by the pointer. From the identified characters, the decompression unit 56b obtains the character string of a length indicated by the pointer from the character strings within the setting unit 73 and reference unit 71, and performs decompression by storing this in the decompression buffer. Note that in the case that the lead bit of the data to be decompressed within the encoding unit 72 is “0”, this is raw data, and in the case the lead bit is “1”, this can be determined to be the pointer. In the case that the data to be decompressed within the encoding unit 72 is raw data, the decompression unit 56b stores the raw data in the decompression buffer. Also, in the case that the data to be decompressed within the encoding unit 72 is the pointer, the decompression unit 56b obtains the character string indicated by the pointer from the character strings within the setting unit 73 and reference unit 71, and stores these in the decompression buffer.

Thus, with the user terminal 52 according to the present embodiment, in the case that the input password does not match the correct password input by the server 51, as long as the remainders D obtained from both passwords do not match, the decompressed data will not be correct. Accordingly, with the user terminal 52 according to the present embodiment, obfuscation can be readily enabled.

The control unit 56 has an integrated circuit such as ASIC (Application Specific Integrated Circuit) or FPGA (Field Programmable Gate Array). Note that the control unit 56 may have an electronic circuit such as a CPU (Central Processing Unit) or MPU (Micro Processing Unit).

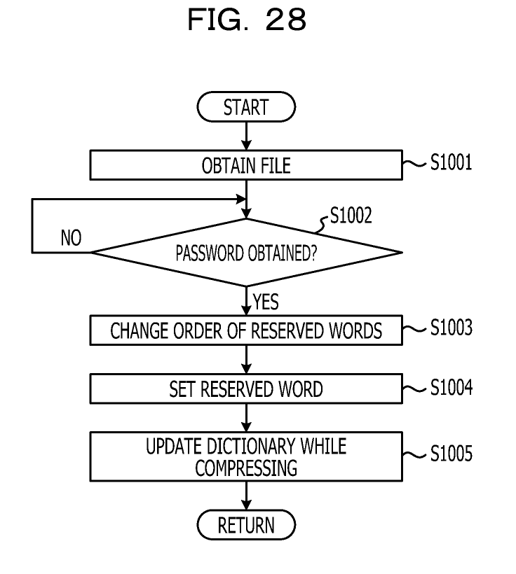

Next, a processing flow of the server 51 according to the present embodiment will be described. FIG. 28 is a flowchart illustrating the procedures of the compression processing according to the fifth embodiment. Various timings may be considered for the execution timing of the compression processing. For example, the compression processing may be executed in the case that the digital content is input from the input unit 5. Note that the processing flow of the system 50 according to the present embodiment is similar to the processing flow illustrated in the sequence diagram of the system 1 according to the first embodiment, so the description will be omitted.

As illustrated in FIG. 28, the compression unit 54b obtains the digital content file (S1001). The generating unit 54a determines whether or not a password has been input from the input unit 5 (S1002). In the case a password has not been input (No in S1002), the generating unit 54a determines again in S1002 whether or not a password has been input from the input unit 5.

On the other hand, in the case that a password is input (Yes in S1002), the generating unit 54a calculates the remainder D in the case that the calculated sum is divided by the number N of registered tags, and performs processing such as the following. That is to say, the generating unit 54a obtains the tags registered in the records in the reserved word table 53a, and generates a character string by joining the obtained tags, using the record of the number indicated by the value of the remainder D as a starting point (S1003). Thus, a character string is generated that arrays reserved words of which the order of registration in the reserved word table 53a has been changed. The compression unit 54b sets the character string generated by the generating unit 54a in the setting unit 73 (S1004). The compression unit 54b compresses the digital content file data while updating the dictionary by sliding the sliding window 70 and updating the data within the reference unit 71 (S1005), stores the processing results in the internal memory of the control unit 54, and returns.

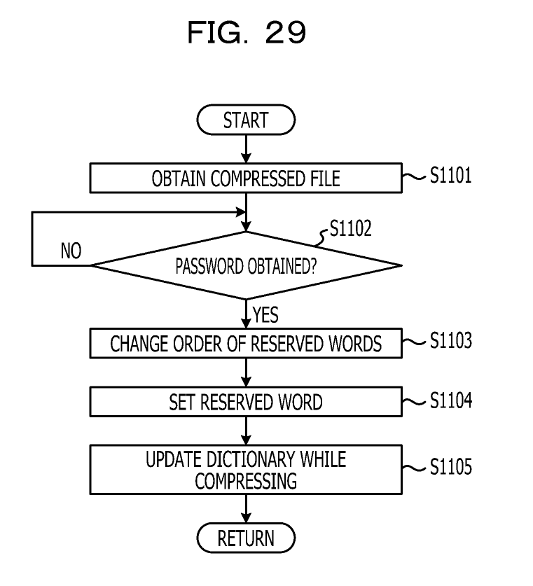

Next, a processing flow of the user terminal 52 according to the present embodiment will be described. FIG. 29 is a flowchart illustrating the procedures of the decompression processing according to the fifth embodiment. With the decompression processing also, the dictionary updating algorithm that is common to the compression processing described in FIG. 28 is used. As illustrated in FIG. 29, the decompression unit 56b obtains a compressed file of digital content (S1101). The generating unit 56a determines whether or not a password has been input by the input unit 10 (S1102). In the case that a password has not been input (No in S1102), the generating unit 56a determines again in S1102 whether a password has been input by the input unit 10.

On the other hand, in the case that a password has been input (Yes in S1102), the generating unit 56a calculates the remainder D in the case that the calculated sum is divided by the number N of registered tags, and performs processing such as the following. That is to say, the generating unit 56a obtains the tags registered in the records in the reserved word table 55a, and generates a character string by joining the obtained tags, using the record of the number indicated by the value of the remainder D as a starting point (S1103). Thus, a character string is generated that arrays reserved words of which the order of registration in the reserved word table 55a has been changed. The decompression unit 56b sets the character string generated by the generating unit 56a in the setting unit 73 (S1104). The decompression unit 56b decompresses the compressed file data while updating the dictionary by sliding the sliding window 70 and updating the data within the reference unit 71 (S1105), stores the processing results in the internal memory of the control unit 56, and returns.

As described above, with the server 51 according to the present embodiment, characters and tags having a high appearance frequency are set in the setting unit 73 at the time of initialization, so the compression efficiency is good. Also, in the server 51 according to the present embodiment, the position of the longest coincident series indicated by the pointer is the address from the lead of the character string set in the setting unit 73. Therefore, according to the server 51 relating to the present embodiment, in the case that an attacker who attempts to decipher the compressed data understands the position of the longest coincident series indicated by the pointer to be the address from the lead of the reference unit 71, the difficulty in deciphering the compressed data by an attacker can be increased.

Also, with the server 51 according to the present embodiment, compression codes can be scrambled with simple processing as compared to encryption processing such as RSA, where a character string is set in the setting unit 73 and the position of the longest coincident series indicated by the pointer is the address from the lead of the character string set in the setting unit 73. Thus, the server 51 according to the present embodiment generates compression data of which deciphering is difficult without performing complicated encryption processing. Accordingly, with the server 51 according to the present embodiment, obfuscating of compression data is easily enabled. Also, the processing cost increase corresponding to the size increase of the data to be processed can be suppressed.

Also, with the server 51 according to the present embodiment, by having the position of the longest coincident series indicated by the pointer to be set as the address from the lead of the character string set in the setting unit 73, scrambling processing is not performed for the compressed data and raw data each time the data is compressed. Therefore, with the server 51 according to the present embodiment, obfuscating of compression data is easily enabled.

Also, with the user terminal 52 according to the present embodiment, in the case that the input password does not match the correct password input by the server 51, as long as the remainders D obtained from both passwords do not match, the decompressed data will not be correct. Accordingly, with the user terminal 52 according to the present embodiment, obfuscation can be readily enabled.

Lastly, a sixth embodiment will be described.

In the fifth embodiment described above, cases of using the LZ 77 compression method has been exemplified, but the apparatus disclosed is not limited to this. Thus, in the sixth embodiment, a case of using Huffman coding as the compression method to compress data will be described.

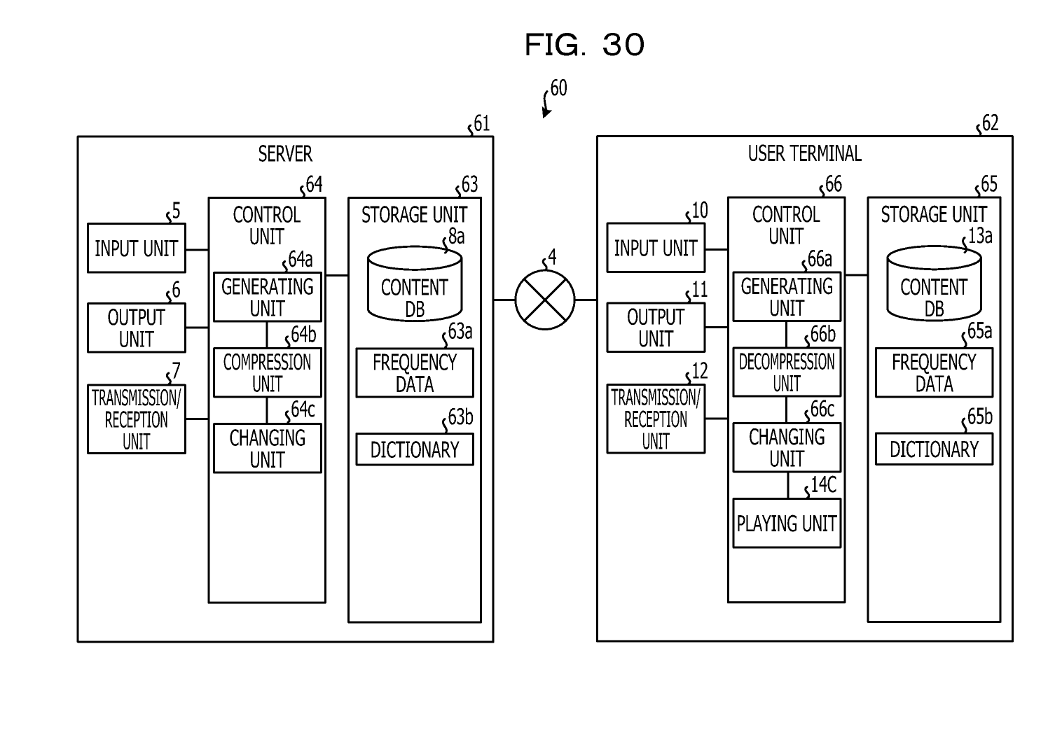

A system according to the sixth embodiment will be described. FIG. 30 is a diagram illustrating an example of a system configuration according to the sixth embodiment. A system 60 according to the present embodiment has a server 61 and user terminal 62. The server 61 differs from the first embodiment in having a storage unit 63 and control unit 64 instead of the storage unit 8 and control unit 9 according to the first embodiment. The user terminal 62 differs from the first embodiment in having a storage unit 65 and control unit 66 instead of the storage unit 13 and control unit 14 according to the first embodiment. Now, in the description below, there are cases where the same reference numerals are appended as in FIGS. 1, 10, 15, 20, and 24 for parts and devices that perform similar functions to the first through fifth embodiments, and descriptions thereof are omitted. The server 61 compresses digital content file data such as a dictionary or electronic book. The server 61 adds later-described frequency data 63a that has been encrypted to the compressed digital content file data, and transmits this to the user terminal 62 via the Internet 4. The user terminal 62 decrypts the received frequency data 63a, and decompresses the received digital content file data. The user terminal 62 plays the decompressed digital content file.

The server 61 has an input unit 5, output unit 6, transmission/reception unit 7, storage unit 63, and control unit 64.

The storage unit 63 stores various types of information. For example, the storage unit 63 stores a content DB 8a, frequency data 63a, and dictionary 63b.

The frequency data 63a is the data registered as appearance frequency for the characters as to all of the characters. The frequency data 63a is generated by a later-described generating unit 64a, and is stored in the storage unit 63.

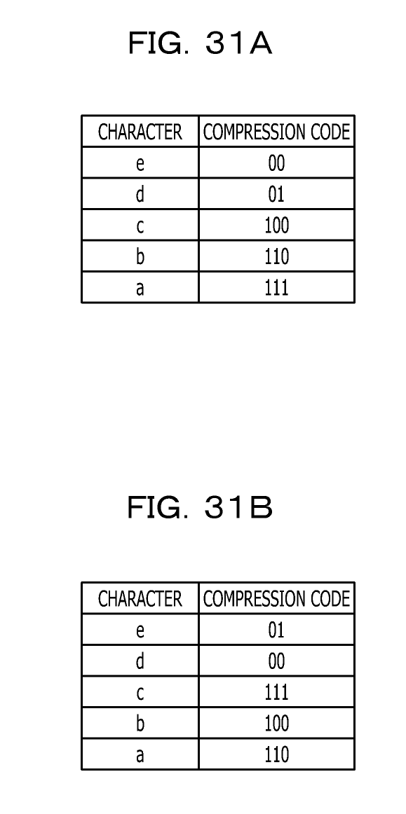

The dictionary 63b is a dictionary expressed by a Huffman tree. A combination of character codes and compression codes is registered in the dictionary 63b by a later-described compression unit 64b. FIG. 31A is a diagram illustrated an example of a dictionary expressed by a Huffman tree. The example in FIG. 31A illustrates a case where a combination of the code of the character “e” and the compression code “00” is registered in the dictionary. Also, the example in FIG. 31A illustrates the case wherein the combination of the code of the character “d” and the compression code “01” is registered in the dictionary. Also, the example in FIG. 31A illustrates the case wherein the combination of the code of the character “c” and the compression code “100” is registered in the dictionary. Also, the example in FIG. 31A illustrates the case wherein the combination of the code of the character “b” and the compression code “110” is registered in the dictionary. Also, the example in FIG. 31A illustrates the case wherein the combination of the code of the character “a” and the compression code “111” is registered in the dictionary.

The storage unit 63 is a semiconductor memory device such as flash memory or a storage apparatus such as a hard disk, optical disk, or the like. Note that the storage unit 63 is not limited to the above-mentioned types of storage apparatuses, and may be RAM (Random Access Memory) or ROM (Read Only Memory).

The control unit 64 has an internal memory to store various types of programs stipulating processing procedures and control data, thereby executing various types of processing. As illustrated in FIG. 30, the control unit 64 has a generating unit 64a, compression unit 64b, and changing unit 64c.

The generating unit 64a counts the number of characters included in the digital content file input by the input unit 5. The generating unit also 64a calculates the number of characters as to the total number of characters. Next, the generating unit 64a encrypts the frequency data 63a indicating the number of characters as to the number of total characters that have been calculated, using an encryption algorithm such as RSA or the like, and stores the encrypted frequency data 63 in the storage unit 63.

The compression unit 64b uses the frequency data 63a and generates the dictionary 63b expressed with a Huffman tree, and stores the generated dictionary 63b in the storage unit 63. The compression unit 64b then compresses the digital content file by Huffman coding, using the dictionary 63b where the combinations of the characters strings and compression codes have been changed by the later-described changing unit 64c. The compression unit 64b registers the compressed digital content file in the content DB 8a for each digital content. Also, upon receiving a transmission request for a digital content file, the compression unit 64b obtains the digital content file from the content DB 8a, obtains the frequency data 63a from the storage unit 63, adds the frequency data 63a to the obtained file, and transmits this to the transmission/reception unit 7.

Of the multiple compression codes registered in the dictionary 63b, the changing unit 64c groups the compression codes having the same compression code length. In the example in FIG. 31A, the changing unit 64c groups the characters “e” and “d” which have the same compression code length into the same group. Also, in the example in FIG. 31A, the changing unit 64c groups the characters “c”, “b”, and “a” which have the same compression code length into the same group. The changing unit 64c changes the compression codes within the same group by calculating the remainder S or the like, with a method similar to the changing method of the compression codes within a predetermined range, which the changing unit 9b according to the first embodiment executes, using the password input by the input unit 5. The changing unit 64c then changes the compression codes in all of the groups. FIG. 31B is a diagram illustrating an example of a case where the dictionary illustrated in the example in FIG. 31A has been changed. The example in FIG. 31B illustrates a case wherein the compression code of the character “e” is changed from “00” to “01”. Also, the example in FIG. 31B illustrates a case wherein the compression code of the character “d” is changed from “01” to “00”. Also, the example in FIG. 31B illustrates a case wherein the compression code of the character “c” is changed from “100” to “111”. Also, the example in FIG. 31B illustrates a case wherein the compression code of the character “b” is changed from “110” to “100”. Also, the example in FIG. 31B illustrates a case wherein the compression code of the character “a” is changed from “111” to “110”. Thus, the changing unit 64c changes the combinations of the character codes registered in the dictionary 63b and the compression codes.

As described above, with the server 61 according to the present embodiment, the compression codes of the dictionary 63b are scrambled, and the combinations of codes and compression codes are changed. Thus, an attacker who attempts to decipher the compressed data, even if understanding the codes and compression codes before changing by unauthorized actions, can have difficulty in deciphering the multiple types of characters, since the combinations are changed.

Also, with the server 61 according to the present embodiment, compression data that is difficult to decipher is generated just by scrambling the compression codes of the dictionary 63b, without performing complicated encryption processing. Accordingly, with the server 61 according to the present embodiment, obfuscating is enabled by simple compression processing. Also, the processing cost increase corresponding to the size increase of the data to be processed can be suppressed.

Also, with the server 61 according to the present embodiment, just by scrambling the compression codes of the dictionary 63b, obfuscating of compression data is readily enabled since scrambling processing is not performed on the compressed data and raw data each time the data is compressed.

The user terminal 62 has an input unit 10, output unit 11, transmission/reception unit 12, storage unit 65, and control unit 66.

The storage unit 65 stores various types of information. For example, the storage unit 65 stores a content DB 8a, frequency data 65a, and dictionary 65b.

The frequency data 65a is data which is the frequency data 63a transmitted from the server 61, decrypted by the later-described generating unit 66a. The frequency data 65a is stored in the storage unit 65 by the generating unit 66a.

Similar to the above-described dictionary 63b, the dictionary 65b is a dictionary expressed by a Huffman tree. A combination of character codes and compression codes is registered in the dictionary 65b by the later-described compression unit 66b.

The storage unit 65 is a semiconductor memory device such as flash memory or a storage apparatus such as a hard disk, optical disk, or the like. Note that the storage unit 65 is not limited to the above-mentioned types of storage apparatuses, and may be RAM (Random Access Memory) or ROM (Read Only Memory).

The control unit 66 has an internal memory to store various types of programs stipulating processing procedures and control data, thereby executing various types of processing. As illustrated in FIG. 30, the control unit 66 has a generating unit 66a, decompression unit 66b, and changing unit 66c, and playing unit 14c.

The generating unit 66a obtains the frequency data 63a added to the digital content file transmitted by the server 61. The generating unit 66a decodes the obtained frequency data 63a, using the encryption algorithm used in the encryption by the server 2. The generating unit 66a then stores the decrypted frequency data 65a in the storage unit 65.

The decompression unit 66b uses the frequency data 65a and generates the dictionary 65b expressed with a Huffman tree, and stores the generated dictionary 65b in the storage unit 65. The decompression unit 66b then decompresses the digital content file by Huffman coding, using the dictionary 65b where the combinations of the characters strings and decompression codes have been changed by the later-described changing unit 66c. The decompression unit 66b registers the decompressed digital content file in the content DB 8a for each digital contents.

Of the multiple compression codes registered in the dictionary 65b, the changing unit 66c groups the compression codes having the same compression code length. The changing unit 66c then uses the password input from the input unit 10 and changes the compression codes within the same group by calculating the remainder S or the like with a method similar to the changing method of the compression codes within a predetermined range, which is executed by the changing unit 9b according to the first embodiment. The changing unit 66c changes the combinations of the character codes registered in the dictionary 65b and the compression codes by changing the compression codes in all of the groups.

Thus, with the user terminal 62 according to the present embodiment, in the case that the input password does not match the correct password input by the server 61, as long as the remainders S or the like obtained from both passwords do not match, the decompressed data will not be correct. Accordingly, with the user terminal 62 according to the present embodiment, obfuscation can be readily enabled.

The control unit 66 has an integrated circuit such as ASIC (Application Specific Integrated Circuit) or FPGA (Field Programmable Gate Array). Note that the control unit 66 may have an electronic circuit such as a CPU (Central Processing Unit) or MPU (Micro Processing Unit).

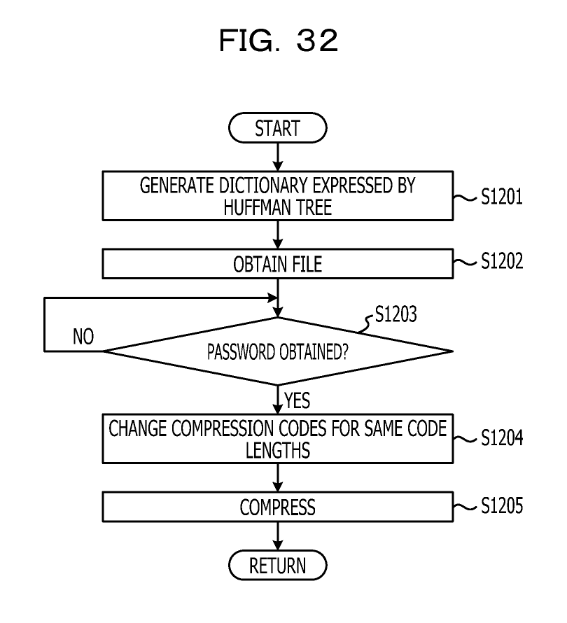

Next, a processing flow of the server 61 according to the present embodiment will be described. FIG. 32 is a flowchart illustrating the procedures of the compression processing according to the sixth embodiment. Various timings may be considered for the execution timing of the compression processing. For example, the compression processing may be executed in the case that the digital content is input from the input unit 5. Note that the processing flow of the system 60 according to the present embodiment is similar to the processing flow illustrated in the sequence diagram of the system 1 according to the first embodiment, so the description will be omitted.

As illustrated in FIG. 32, the compression unit 64b uses the frequency data 63a and generates the dictionary 63b expressed by a Huffman tree, and stores the generated dictionary 63b in the storage unit 63 (S1201). The compression unit 64b obtains the digital content file (S1202). The changing unit 64c determines whether or not a password has been input from the input unit 5 (S1203). In the case that a password has not been input (No in S1203), the changing unit 64c determines again in S1203 whether or not a password has not been input from the input unit 5.

On the other hand, in the case that a password has been input (Yes in S1203), the changing unit 64c groups the compression codes having the same compression code length, for the multiple compression codes registered in the dictionary 63b, and changes the compressing codes in each of all groups (S1204). The compression unit 64b compresses the digital content file data using the dictionary 63b (S1205), stores the processing results in the internal memory of the control unit 64, and returns.

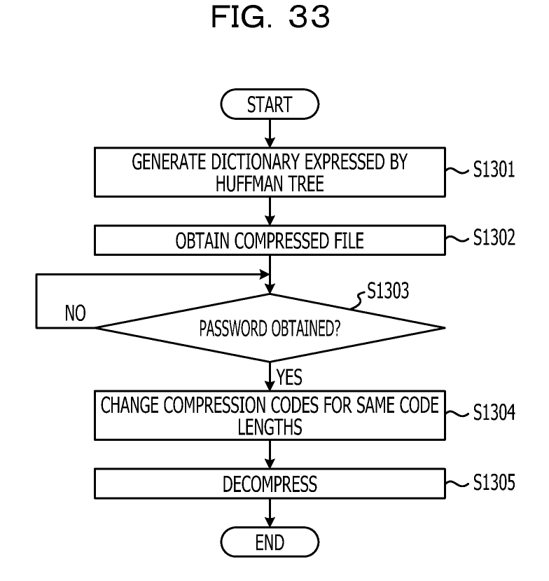

Next, a processing flow of the user terminal 62 according to the present embodiment will be described. FIG. 33 is a flowchart illustrating the procedures of the decompression processing according to the sixth embodiment. As illustrated in FIG. 33, the decompression unit 66b uses the frequency data 65a and generates the dictionary 65b expressed by a Huffman tree, and stores the generated dictionary 65b in the storage unit 65 (S1301). The decompression unit 66b obtains the digital content file (S1302). The changing unit 66c determines whether or not a password has been input from the input unit 10 (S1303). In the case that a password has not been input (No in S1303), the changing unit 66c determines again in S1303 whether or not a password has not been input by the input unit 10.

On the other hand, in the case that a password has been input (Yes in S1303), the changing unit 66c groups the compression codes having the same compression code length, for the multiple compression codes registered in the dictionary 65b, and changes the compressing codes in each of the groups (S1304). The decompression unit 66b decompresses the digital content file data using the dictionary 65b (S1305), stores the processing results in the internal memory of the control unit 66, and returns.

As described above, with the server 61 according to the present embodiment, the compression codes of the dictionary 63b are scrambled, and the combinations of codes and compression codes are changed. Thus, an attacker who attempts to decipher the compressed data, even if understanding the codes and compression codes before changing by illegal actions, can have difficulty in deciphering the multiple types of characters, since the combinations are changed.

Also, with the server 61 according to the present embodiment, compression data that is difficult to decipher is generated just by scrambling the compression codes of the dictionary 63b, without performing complicated encryption processing. Accordingly, with the server 61 according to the present embodiment, obfuscating is enabled by simple compression processing. Also, the processing cost increase corresponding to the size increase of the data to be processed can be suppressed.

Also, with the server 61 according to the present embodiment, just by scrambling the compression codes of the dictionary 63b, obfuscating of compression data is readily enabled since scrambling processing is not performed on the compressed data and raw data each time the data is compressed.

Also, with the user terminal 62 according to the present embodiment, in the case that the input password does not match the correct password input by the server 61, as long as the remainders S or the like obtained from both passwords do not match, the decompressed data will not be correct. Accordingly, with the user terminal 62 according to the present embodiment, obfuscation can be readily enabled.

Now, embodiments according to disclosed apparatuses have been described up to this point. As described above, the servers and user terminals according to the embodiments use a common dictionary updating algorithm. Also, the present disclosure may be applied to various types of other embodiments, besides the embodiments described above. Thus, other embodiments included in the present disclosure will be described below.

For example, of the processing described in the first through sixth embodiment as being performed automatically, all or a portion of the processing described may be performed manually. Also, of the processing described in the first through sixth embodiment as being performed manually, all or a portion of the processing described may be performed automatically with a commonly used method.

Also, depending on various types of loads and use situations, the processing of the steps for the processing described according to the embodiments may be optionally divided into smaller segments, or aggregated. Also, steps may be omitted.

Also, depending on various types of loads and use situations, the order of the processing of the steps for the processing described according to the embodiments may be changed. For example, the processing in S1202 can be performed before performing the processing in S1201. Also, the processing in S1302 can be performed before performing the processing in S1301.

Also, the configuration elements of the apparatuses illustrated in the diagrams are conceptual as to the functions thereof, and are not necessarily configured physically as illustrated in the diagrams. That is to say, specific situations of dispersion or integration of the apparatuses are not limited to those illustrated in the diagrams, and depending on various types of loads and use situations, all or a portion may be configured in a manner dispersed or integrated functionally or physically in optional units.

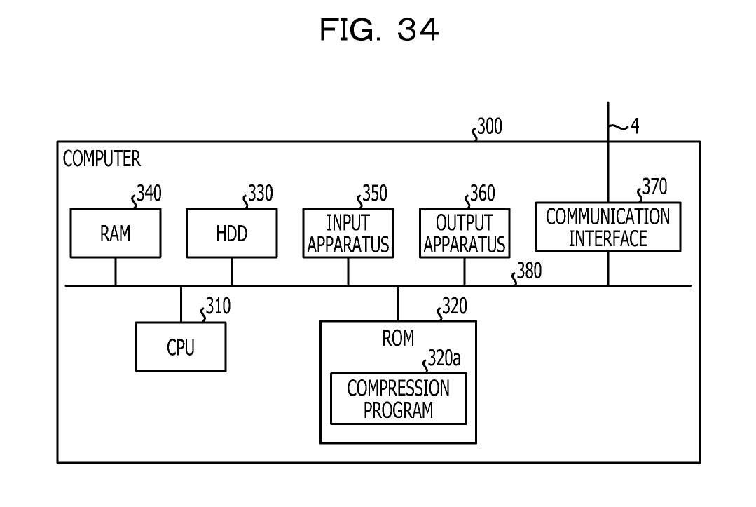

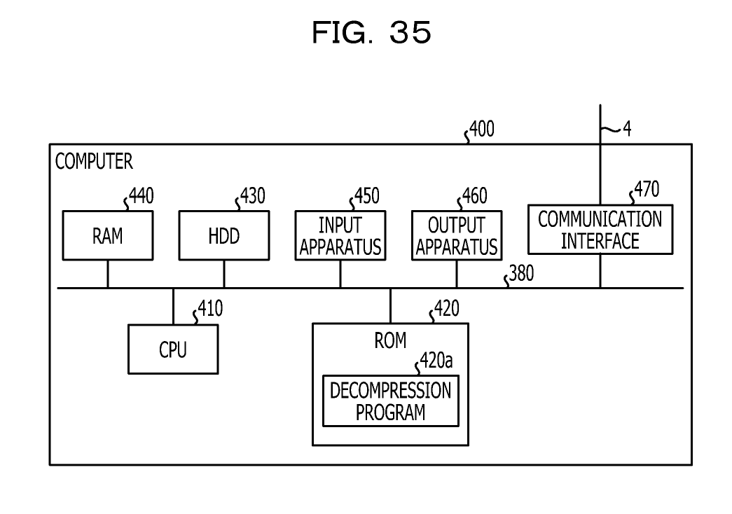

Also, the processing of the user terminals described with the first through sixth embodiments may be realized by executing program prepared beforehand on a computer system such as a personal computer or work station. Thus, an example of a computer executing a compression program having similar functions as the servers described in the embodiments above will be described, with reference to FIG. 34. Also, an example of a computer executing a decompression program having similar functions as the user terminals described in the embodiments above will be described, with reference to FIG. 35.

FIG. 34 illustrates an example of a computer that executes a compression program. As illustrated in FIG. 34, a computer 300 has a CPU (Central Processing Unit) 310, ROM (Read Only Memory) 320, HDD (Hard Disk Drive) 330, and RAM (Random Access Memory) 340. Also, the computer 300 has an input apparatus 350, output apparatus 360, and a communication interface 370 that is connected to the Internet 4. These parts 310 through 370 are connected via a bus 380. The CPU 310 is an example of a processor which reads out and executes the converting program, which is the compression program for example, from the ROM 340. The processor is a hardware to carry out operations based on at least one program (such as the converting program) and control other hardware, such as the CPU 310, a GPU (Graphics Processing Unit), FPU (Floating point number Processing Unit) and DSP (Digital signal Processor). The processor runs the program stored in the ROM 340 or the HDD 330 and controls the respective hardware portions illustrated in FIG. 34, so as to implement respective functions by means of the control unit 9, 23, 33, 43, 54 and 64, for example.

The input apparatus 350 includes various types of input devices, and for example includes a keyboard and a mouse. The input apparatus 350 corresponds to the input units 5 which the servers in the embodiments have.

The output apparatus 360 includes various types of output devices, and for example includes a liquid crystal display. The output apparatus 360 corresponds to the output units 6 which the servers in the embodiments have.

The communication interface 370 corresponds to the transmission/reception unit 7 which the servers in the embodiments have.

A compression program 320a that produces similar functions as the compression unit, changing unit, and generating unit illustrated in the embodiments above is stored beforehand in the ROM 320. Note that the compression program 320a may be divided up as appropriate.

The CPU 310 reads out the compression program 320a from the ROM 320 and executes to produce the functions as the compression unit, changing unit, and generating unit.

A content DB, dictionary, reserved word table, and frequency data are provided in the HDD 330. Of these, each of the content DB, dictionary, and reserved word table correspond to the content DB 8a, dictionaries 8b and 63b, and reserved word table 53a, respectively. Also, the frequency data corresponds to the frequency data 63a.

The CPU 310 reads out the content DB, dictionary, reserved word table, and frequency data, and stores these in the RAM 340. Further, the CPU 310 uses the content DB, dictionary, reserved word table, and frequency data stored in the RAM 340 to execute the compression program. Note that the data stored in the RAM 340 does not have to have all of the data constantly be stored in the RAM 340, and it is acceptable for only the data for processing to be stored in the RAM 340.

FIG. 35 is a diagram illustrating a computer executing a decompression program. As illustrated in FIG. 35, the computer 400 has a CPU 410, ROM 420, HDD 430, and RAM 440. Also, the computer 400 has an input apparatus 450, output apparatus 460, and a communication interface 470 that is connected to the Internet 4. These parts 410 through 470 are connected via a bus 380. The CPU 410 is an example of a processor which reads out and executes the converting program, which is the decompression program for example, from the ROM 440. The processor is a hardware to carry out operations based on at least one program (such as the converting program) and control other hardware, such as the CPU 410, a GPU (Graphics Processing Unit), FPU (Floating point number Processing Unit) and DSP (Digital signal Processor). The processor runs the program stored in the ROM 440 or the HDD 430 and controls the respective hardware portions illustrated in FIG. 34, so as to implement respective functions by means of the control unit 14, 24, 34, 44, 56 and 66, for example.

The input apparatus 450 includes various types of input devices, and for example includes a keyboard and a mouse. The input apparatus 450 corresponds to the input units 10 which the user terminals in the embodiments have.

The output apparatus 460 includes various types of output devices, and for example includes a liquid crystal display. The output apparatus 460 corresponds to the output units 11 which the user terminals in the embodiments have.

The communication interface 470 corresponds to the transmission/reception unit 12 which the servers in the embodiments have.

A decompression program 420a that produces similar functions as the generating unit, decompression unit, and changing unit illustrated in the embodiments above is stored beforehand in the ROM 420. Note that the decompression program 420a may be divided up as appropriate.

The CPU 410 reads out the decompression program 420a from the ROM 420 and executes.

A content DB, dictionary, reserved word table, and frequency data are provided in the HDD 430. Of these, each of the content DB, dictionary, and reserved word table correspond to the content DB 13a, dictionaries 13b and 65b, and reserved word table 55a, respectively. Also, the frequency data corresponds to the frequency data 65a.

The CPU 410 reads out the content DB, dictionary, reserved word table, and frequency data, and stores these in the RAM 440. Further, the CPU 410 uses the content DB, dictionary, reserved word table, and frequency data stored in the RAM 440 to execute the compression program. Note that the data stored in the RAM 440 does not have to have all of the data constantly be stored in the RAM 440, and it is acceptable for only the data for processing to be stored in the RAM 440.

Note that the compression program and decompression program described above does not necessarily have to be stored in the ROM from the beginning.

For example, the programs may be stored in a “portable physical medium” such as a flexible disk (FD), CD-ROM, DVD disk, magneto-optical disk, or IC card that is inserted into the computer. The computer may read out and execute the program from such medium.

Further, the programs may be stored in “another computer (or server)” that is connected to the computer via a public circuit, Internet, LAN, WAN, or the like. The computer may read out and execute the program from these.

According to the above-described embodiments, processing cost increases that are in accordance with the size increase of data to be processed can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A converting method comprising:
storing correspondence of each of first-type coded information, included in a first-type coded information group, and one of second-type coded information, included in a second-type coded information group, based on input information, by a processor; and
converting, when input data includes the first-type coded information, first-type coded information in the input data into second-type coded information, based on the correspondence.

2. The converting method according to claim 1, wherein
the correspondence is scrambled based on a certain scramble algorithm and the input information.

3. The converting method according to claim 1, wherein
the first-type coded information indicates a character code, and
the second-type coded information indicates a compression code.

4. The converting method according to claim 1, wherein
the first-type coded information indicates a compression code, and
the second-type coded information indicates a character code.

5. The converting method according to claim 1, wherein
the one of second-type coded information is determined according to results of having used the input information for an argument of calculations with a predetermined algorithm.

6. A computer-readable recording medium storing converting program that causes a computer to execute procedure, the procedure comprising:
storing correspondence of each of first-type coded information, included in a first-type coded information group, and one of second-type coded information, included in a second-type coded information group, based on input information; and
converting, when input data includes the first-type coded information, first-type coded information in the input data into second-type coded information, based on the correspondence.

7. The recording medium according to claim 6, wherein the procedure further comprising:
the correspondence is scrambled based on a certain scramble algorithm and input information.

8. The recording medium according to claim 6, wherein
the first-type coded information indicates a character code, and
the second-type coded information indicates a compression code.

9. The recording medium according to claim 6, wherein
the first-type coded information indicates a compression code, and
the second-type coded information indicates a character code.

10. The recording medium according to claim 6, wherein
the one of second-type coded information is determined according to results of having used the input information for an argument of calculations with a predetermined algorithm.

11. A converting apparatus comprising:
a memory that stores a conversion dictionary which indicates a correspondence relation of each of first-type coded information, included in a first-type coded information group, and one of second-type coded information, included in a second-type coded information group, determined based on input information; and
a processor that executes a procedure, the procedure includes:
converting, when input data includes the first-type coded information, first-type coded information in the input data into second-type coded information, based on the correspondence.

12. The converting apparatus according to claim 11, wherein
the correspondence is scrambled based on a certain scramble algorithm and input information.

13. The converting apparatus according to claim 11, wherein
the first-type coded information indicates a character code, and
the second-type coded information indicates a compression code.

14. The converting apparatus according to claim 11, wherein
the first-type coded information indicates a compression code, and
the second-type coded information indicates a character code.

15. The converting apparatus according to claim 11, wherein
the one of second-type coded information is determined according to results of having used the input information for an argument of calculations with a predetermined algorithm.

16. A converting method comprising:
converting, by a processor, a piece of first type of coding information into a scrambled piece of second type of coding information based on a conversion dictionary which indicates a correspondence relation of pieces of the first type of coding information and encrypted pieces of the second type of coding information, in association with the piece of the first type of coding information.
